(19) United States
(12) Patent Application Publication
(10) Pub. No.: US 2019/0091976 A1
(43) Pub. Date: Mar. 28, 2019

(54) BARRIER COMPOSITES

(71) Applicant: 3M INNOVATIVE PROPERTIES COMPANY, St Paul, MN (US)

(72) Inventors: Mark A. ROEHRIG, Stillwater, MN (US); John P. BAETZOLD, North St. Paul, MN (US); Evan L. BREEDLOVE, Woodbury, MN (US); Jacob P. JOHNSON, St. Paul, MN (US); Hui LUO, Woodbury, MN (US); Joseph M. PIEPER, Atlanta, GA (US); Jilliann M. NELSON, Shoreview, MN (US); Serena L. SCHLEUSNER, Roberts, WI (US)

(21) Appl. No.: 16/073,319

(22) PCT Filed: Feb. 1, 2017
(86) PCT No.: PCT/US2017/015937

§ 371 Date: Jul. 26, 2018

Related U.S. Application Data
(60) Provisional application No. 62/289,420, filed on Feb. 1, 2016.

(51) Int. Cl. B32B 27/08; B32B 7/12; B32B 37/12

(52) U.S. Cl. CPC B32B 27/08; B32B 7/12; B32B 2457/00; B32B 2307/7244; B32B 2307/7246; B32B 37/12

(57) ABSTRACT

A barrier composite comprises (a) a gas-barrier film, (b) a polymeric transfer layer disposed on the gas-barrier film, and (c) a release liner disposed on the polymeric transfer layer opposite the gas-barrier film.

### FIELD

This invention relates to barrier composites useful for protecting electronic devices or components of electronic devices from moisture and oxygen.

### BACKGROUND

Many thin-film organic and inorganic devices are susceptible to degradation from exposure to moisture and oxygen. Such devices, particularly handheld devices, are typically encapsulated by glass in order to protect them from contact with moisture and oxygen. The handheld device market, however, is trending toward thinner, lighter weight, curved and even foldable form factors, but glass significantly impairs the flexibility of the device. Barrier film layers deposited onto flexible polymer films such as polyethylene terephthalate (PET) film substrates are therefore gaining more interest for these non-planar and flexible form factors. However, these increasingly thinner, non-planar and flexible form factors place greater demands on the performance of barrier films and their mechanical durability.

PET films are currently a preferred substrate for supporting barrier film layers, but as constructions are made thinner and thinner, they can suffer in mechanical and thermal stability. Additionally, PET's inherently high refractive index (i.e., n>1.6), light absorption at short wavelengths and birefringent properties can compromise the opto-electronic performance that is often the key to success of handheld devices.

### SUMMARY

In view of the foregoing, we recognize that there is a need in the art for barrier constructions that are thinner without compromising mechanical durability or optical performance.

Briefly, in one aspect, the present invention provides a barrier composite comprising (a) a gas-barrier film, (b) a polymeric transfer layer disposed on the gas-barrier film, and (c) a release liner disposed on the polymeric transfer layer opposite the gas-barrier film.

In another aspect, the present invention provides a double barrier composite comprising (a) a first barrier composite comprising a first gas-barrier film disposed on a first polymeric transfer layer, (b) a second barrier composite comprising a second gas-barrier film disposed on a second polymeric transfer layer, and (c) a layer comprising a cross-linked polymer layer disposed between the first gas-barrier film and the second gas-barrier film.

In yet another aspect, the present invention provides an encapsulated thin film device comprising a double barrier composite encapsulating a thin film device.

In still another aspect, the present invention provides a barrier composite comprising a gas-barrier film and a polymeric transfer layer disposed on the polymeric transfer layer wherein the barrier composite does not show barrier failure at a tensile strain of 1%.

In still another aspect, the present invention provides a barrier composite comprising a gas-barrier film and a polymeric transfer layer disposed on the polymeric transfer layer wherein the barrier composite does not show barrier failure after 100,000 cycles at a tensile strain of 1%.

The present invention also provides a method of encapsulating a thin film device comprising (a) providing a barrier composite comprising a gas-barrier film, a polymeric transfer layer disposed on the gas-barrier film and a release liner disposed on the polymeric transfer layer opposite the gas-barrier film; (b) providing a thin film device; and (c) adhering the barrier composite to the thin film device.

The present invention further provides a method of encapsulating a thin film device comprising (a) providing a double barrier composite comprising (i) a first barrier composite comprising a first gas-barrier film disposed on a first polymeric transfer layer, and a first release liner disposed on the opposite side of the first polymeric transfer layer, (ii) a second barrier composite comprising a second gas-barrier film disposed on a second polymeric transfer layer, and a second release liner disposed on the opposite side of the second polymeric transfer layer, and (iii) a layer comprising a cross-linked polymer layer disposed between the first gas-barrier film and the second gas-barrier film; (b) providing a thin film device; (c) removing the first release liner; and (d) adhering the double barrier composite to the thin film device.

The barrier composites of the invention can be transferred onto an opto-electronic device to provide a “substrate-less” barrier solution for protection from moisture and oxygen. The barrier composites can thus be used to produce thinner opto-electronic devices without compromising performance. In some embodiments, barrier composites of the invention are, for example, less than about 50, about 25, or even about 10 microns thick.

In addition, the barrier composites of the invention can provide a mechanical advantage in that they can lead to a reduction in flexural stiffness and in shear stresses experienced by devices incorporating the substrate-less barrier. In some embodiments, barrier composites of the invention have a Young's modulus, for example, of less than about 10, about 5, about 3, about 2 or even about 1.5 GPa.

### BRIEF DESCRIPTION OF THE DRAWINGS

FIG. 1 is schematic diagram of a barrier composite according to an embodiment of the present invention.

FIG. 2 is a schematic diagram of a double barrier composite according to an embodiment of the present invention.

FIG. 3 is a schematic diagram of a double barrier composite according to an embodiment of the present invention.

FIG. 4 shows optical transmission data from the Examples.

FIG. 5 shows optical retardance data from the Examples.

### DETAILED DESCRIPTION

### Gas-Barrier Film

The barrier composites of the invention comprise a gas-barrier film. Gas-barrier films have a low permeability to oxygen and can be used to help prevent goods such as foods, electronics and pharmaceutical products from being deteriorated by contact with oxygen. Typically food grade gas-barrier films have oxygen transmission rates of less than about 1 cm³/m²/day at 20° C. and 65% relative humidity. Preferably, the gas-barrier film also has barrier properties to moisture. In some embodiments, the gas-barrier film has a thickness of about 0.3 microns to about 10 microns, or about 1 micron to about 8 microns.

Examples of polymeric gas-barrier films include ethyl vinyl alcohol copolymer (EVOH) films such as polyethylene EVOH films and polypropylene EVOH films; polyamide films such as coextruded polyamide/polyethylene films, coextruded polypropylene/polyamide/polypropylene films; and polyethylene films such as low density, medium density or high density polyethylene films and coextruded polyethylene/ethyl vinyl acetate films. Polymeric gas-barrier films can also be metallized, for example, coating a thin layer of metal such as aluminum on the polymer film.

Examples of inorganic gas-barrier films include films comprising silicon oxide, silicon nitride, silicon oxynitride, aluminum oxide, silicon aluminum oxide, diamond-like films, diamond-like glass and foils such as aluminum foil.

Preferably, the gas-barrier film is flexible. For some applications, it is also preferable that the gas-barrier film be visible light-transmissive. As used herein, the term “visible light-transmissive” means having an average transmission over the visible portion of the spectrum (for example, between 400 nm and 700 nm) of at least about 80%, preferably at least about 88% or 90%.

For some applications, protection from moisture and oxygen is required. For particularly sensitive applications an “ultra-barrier film” may be necessary. Ultra-barrier films typically have an oxygen transmission rate less than about 0.005 cc/m²/day at 23° C. and 90% RH and a water vapor transmission rate of less than about 0.005 g/m²/day at 23° C. and 90% RH. Some ultra-barrier films are multilayer films comprising an inorganic visible light-transmissive layer disposed between polymer layers. One example of a suitable ultra-barrier film comprises a visible light-transmissive inorganic barrier layer disposed between polymers having a glass transition temperature (Tg) greater than or equal to that of heat-stabilized polyethylene terephthalate (HSPET). In some embodiments, the inorganic layer has a thickness of about 2 nm to about 40 nm, or about 3 nm to about 30 nm. In some embodiments, the polymer layers have a thickness of about 100 nm to about 1500 nm, or about 300 nm to about 1100 nm.

A variety of polymers having a Tg greater than or equal to that of HSPET can be employed. Volatilizable monomers that form suitably high Tg polymers are especially preferred. Preferably the first polymer layer has a Tg greater than that of PMMA, more preferably a Tg of at least about 110° C., yet more preferably at least about 150° C., and most preferably at least about 200° C. Especially preferred monomers that can be used to form the first layer include urethane acrylates (e.g., CN-968, Tg=about 84° C. and CN-983, Tg=about 90° C., both commercially available from Sartomer Co.), isobornyl acrylate (e.g., SR-506, commercially available from Sartomer Co., Tg=about 88° C.), dipentaerythritol pentaacrylates (e.g., SR-399, commercially available from Sartomer Co., Tg=about 90° C.), epoxy acrylates blended with styrene (e.g., CN-120S80, commercially available from Sartomer Co., Tg=about 95° C.), di-trimethylolpropane tetraacrylates (e.g., SR-355, commercially available from Sartomer Co., Tg=about 98° C.), diethylene glycol diacrylates (e.g., SR-230, commercially available from Sartomer Co., Tg=about 100° C.), 1,3-butylene glycol diacrylate (e.g., SR-212, commercially available from Sartomer Co., Tg=about 101° C.), pentaacrylate esters (e.g., SR-9041, commercially available from Sartomer Co., Tg=about 102° C.), pentaerythritol tetraacrylates (e.g., SR-295, commercially available from Sartomer Co., Tg=about 103° C.), pentaerythritol triacrylates (e.g., SR-444, commercially available from Sartomer Co., Tg=about 103° C.), ethoxylated (3) trimethylolpropane triacrylates (e.g., SR-454, commercially available from Sartomer Co., Tg=about 103° C.), ethoxylated (3) trimethylolpropane triacrylates (e.g., SR-454HP, commercially available from Sartomer Co., Tg=about 103° C.), alkoxylated trifunctional acrylate esters (e.g., SR-9008, commercially available from Sartomer Co., Tg=about 103° C.), dipropylene glycol diacrylates (e.g., SR-508, commercially available from Sartomer Co., Tg=about 104° C.), neopentyl glycol diacrylates (e.g., SR-247, commercially available from Sartomer Co., Tg=about 107° C.), ethoxylated (4) bisphenol a dimethacrylates (e.g., CD-450, commercially available from Sartomer Co., Tg=about 108° C.), cyclohexane dimethanol diacrylate esters (e.g., CD-406, commercially available from Sartomer Co., Tg=about 110° C.), isobornyl methacrylate (e.g., SR-423, commercially available from Sartomer Co., Tg=about 110° C.), cyclic diacrylates (e.g., SR-833, commercially available from Sartomer Co., Tg=about 186° C.) and tris (2-hydroxy ethyl) isocyanurate triacrylate (e.g., SR-368, commercially available from Sartomer Co., Tg=about 272° C.), acrylates of the foregoing methacrylates and methacrylates of the foregoing acrylates.

The first polymer layer can be formed by applying a layer of a monomer or oligomer to the substrate and crosslinking the layer to form the polymer in situ, e.g., by flash evaporation and vapor deposition of a radiation-crosslinkable monomer, followed by crosslinking using, for example, an electron beam apparatus, UV light source, electrical discharge apparatus or other suitable device. Coating efficiency can be improved by cooling the support. The monomer or oligomer can also be applied to the substrate using conventional coating methods such as roll coating (e.g., gravure roll coating) or spray coating (e.g., electrostatic spray coating), then crosslinked as set out above. The first polymer layer can also be formed by applying a layer containing an oligomer or polymer in solvent and drying the thus-applied layer to remove the solvent. Plasma polymerization may also be employed if it will provide a polymeric layer having a glassy state at an elevated temperature, with a glass transition temperature greater than or equal to that of HSPET. Most preferably, the first polymer layer is formed by flash evaporation and vapor deposition followed by crosslinking in situ, e.g., as described in U.S. Pat. No. 4,696,719 (Bischoff), U.S. Pat. No. 4,722,515 (Ham), U.S. Pat. No. 4,842,893 (Yializis et al.), U.S. Pat. No. 4,954,371 (Yializis), U.S. Pat. No. 5,018,048 (Shaw et al.), U.S. Pat. No. 5,032,461 (Shaw et al.), U.S. Pat. No. 5,097,800 (Shaw et al.), U.S. Pat. No. 5,125,138 (Shaw et al.), U.S. Pat. No. 5,440,446 (Shaw et al.), U.S. Pat. No. 5,547,908 (Furuzawa et al.), U.S. Pat. No. 6,045,864 (Lyons et al.), U.S. Pat. No. 6,231,939 (Shaw et al.) and U.S. Pat. No. 6,214,422 (Yializis); in published PCT Application No. WO 00/26973 (Delta V Technologies, Inc.); in D. G. Shaw and M. G. Langlois, “A New Vapor Deposition Process for Coating Paper and Polymer Webs”, 6th International Vacuum Coating Conference (1992); in D. G. Shaw and M. G. Langlois, “A New High Speed Process for Vapor Depositing Acrylate Thin Films: An Update”, Society of Vacuum Coaters 36th Annual Technical Conference Proceedings (1993); in D. G. Shaw and M. G. Langlois, “Use of Vapor Deposited Acrylate Coatings to Improve the Barrier Properties of Metallized Film”, Society of Vacuum Coaters 37th Annual Technical Conference Proceedings (1994); in D. G. Shaw, M. Roehrig, M. G. Langlois and C. Sheehan, “Use of Evaporated Acrylate Coatings to Smooth the Surface of Polyester and Polypropylene Film Substrates”, RadTech (1996); in J. Affinito, P. Martin, M. Gross, C. Coronado and E. Greenwell, “Vacuum deposited polymer/metal multilayer films for optical application”, Thin Solid Films 270, 43-48 (1995); and in J. D. Affinito, M. E. Gross, C. A. Coronado, G. L. Graff, E. N. Greenwell and P. M. Martin, “Polymer-Oxide Transparent Barrier Layers”, Society of Vacuum Coaters 39th Annual Technical Conference Proceedings (1996).

The smoothness and continuity of each polymer layer and its adhesion to the underlying layer preferably is enhanced by appropriate pretreatment. A preferred pretreatment regimen employs an electrical discharge in the presence of a suitable reactive or non-reactive atmosphere (e.g., plasma, glow discharge, corona discharge, dielectric barrier discharge or atmospheric pressure discharge); chemical pretreatment or flame pretreatment. These pretreatments help make the surface of the underlying layer more receptive to formation of the subsequently applied polymeric layer. Plasma pretreatment is particularly preferred. A separate adhesion promotion layer which may have a different composition than the high Tg polymer layer may also be utilized atop an underlying layer to improve interlayer adhesion. The adhesion promotion layer can be, for example, a separate polymeric layer or a metal-containing layer such as a layer of metal, metal oxide, metal nitride or metal oxynitride. The adhesion promotion layer may have a thickness of a few nm (e.g., 1 or 2 nm) to about 50 nm, and can be thicker if desired.

The desired chemical composition and thickness of the first polymer layer will depend in part on the nature and surface topography of the underlying layer. The thickness preferably is sufficient to provide a smooth, defect-free surface to which the subsequent first inorganic barrier layer can be applied. For example, the first polymer layer may have a thickness of a few nm (e.g., 2 or 3 nm) to about 5 μm, and can be thicker if desired.

One or more visible light-transmissive inorganic barrier layers separated by a polymer layer having a Tg greater than or equal to that of HSPET lie atop the first polymer layer. These layers can respectively be referred to as the “first inorganic barrier layer”, “second inorganic barrier layer” and “second polymer layer”. Additional inorganic barrier layers and polymer layers can be present if desired, including polymer layers that do not have a Tg greater than or equal to that of HSPET. Preferably however each neighboring pair of inorganic barrier layers is separated only by a polymer layer or layers having a Tg greater than or equal to that of HSPET, and more preferably only by a polymer layer or layers having a Tg greater than that of PMMA.

The inorganic barrier layers do not have to be the same. A variety of inorganic barrier materials can be employed. Preferred inorganic barrier materials include metal oxides, metal nitrides, metal carbides, metal oxynitrides, metal oxyborides, and combinations thereof, e.g., silicon oxides such as silica, aluminum oxides such as alumina, titanium oxides such as titania, silicon aluminum oxides, indium oxides, tin oxides, indium tin oxide (“ITO”), tantalum oxide, zirconium oxide, niobium oxide, boron carbide, tungsten carbide, silicon carbide, aluminum nitride, silicon nitride, boron nitride, aluminum oxynitride, silicon oxynitride, boron oxynitride, zirconium oxyboride, titanium oxyboride, and combinations thereof. Indium tin oxide, silicon oxide, aluminum oxide, silicon aluminum oxide and combinations thereof are especially preferred inorganic barrier materials. ITO is an example of a special class of ceramic materials that can become electrically conducting with the proper selection of the relative proportions of each elemental constituent. The inorganic barrier layers preferably are formed using techniques employed in the film metallizing art such as sputtering (e.g., cathode or planar magnetron sputtering), evaporation (e.g., resistive or electron beam evaporation), chemical vapor deposition, atomic layer deposition, plating and the like. Most preferably the inorganic barrier layers are formed using sputtering, e.g., reactive sputtering Enhanced barrier properties have been observed when the inorganic layer is formed by a high energy deposition technique such as sputtering compared to lower energy techniques such as conventional chemical vapor deposition processes. The smoothness and continuity of each inorganic barrier layer and its adhesion to the underlying layer can be enhanced by pretreatments (e.g., plasma pretreatment) such as those described above with reference to the first polymer layer.

The inorganic barrier layers do not have to have the same thickness. The desired chemical composition and thickness of each inorganic barrier layer will depend in part on the nature and surface topography of the underlying layer and on the desired optical properties for the barrier assembly. The inorganic barrier layers preferably are sufficiently thick so as to be continuous, and sufficiently thin so as to ensure that the barrier assembly and articles containing the assembly will have the desired degree of visible light transmission and flexibility. Preferably the physical thickness (as opposed to the optical thickness) of each inorganic barrier layer is about 3 to about 150 nm, more preferably about 4 to about 75 nm.

The second polymer layers that separate the first, second and any additional inorganic barrier layers do not have to be the same, and do not all have to have the same thickness. A variety of second polymer layer materials can be employed. Preferred second polymer layer materials include those mentioned above with respect to the first polymer layer. Preferably the second polymer layer or layers are applied by flash evaporation and vapor deposition followed by crosslinking in situ as described above with respect to the first polymer layer. A pretreatment such as those described above (e.g., plasma pretreatment) preferably also is employed prior to formation of a second polymer layer. The desired chemical composition and thickness of the second polymer layer or layers will depend in part on the nature and surface topography of the underlying layer(s). The second polymer layer thickness preferably is sufficient to provide a smooth, defect-free surface to which a subsequent inorganic barrier layer can be applied. Typically the second polymer layer or layers may have a lower thickness than the first polymer layer. For example, each second polymer layer may have a thickness of about 5 nm to about 10 μm, and can be thicker if desired.

Flexible visible light-transmissive ultra-barrier films and their manufacture are described, for example, in U.S. Pat. No. 7,940,004 (Padiyath et al.), which is herein incorporated by reference.

Commercially available ultra-barrier films include, for example, FTB 3-50 and FTB 3-125 available from 3M Company.

### Polymeric Transfer Layer

The barrier composites of the invention comprise a polymeric transfer layer disposed on the gas-barrier film. Suitable polymeric transfer layers have good adhesion to the gas-barrier film. The polymeric transfer layer should also adequately adhere to the release liner so that the liner remains in place during processing and transport of the barrier composite, yet cleanly transfer off (i.e., release from) the release liner when the liner is intentionally removed. Preferably, the polymeric transfer layer is mechanically robust so that it can support itself but remains flexible enough to resist cracking. In some embodiments, the polymeric transfer layer can provide durability to the barrier composite. The polymeric transfer layer is typically provided as a coating (e.g. solution coated) and is not a freestanding layer or film. In some embodiments, the transfer layer has a thickness of about 0.1 microns to about 8 microns, or about 0.5 microns to about 6 microns.

In some embodiments, the polymeric transfer layer can be made as described in WO 2013/116103 (Kolb et al.) and WO 2013/116302 (Kolb et al.), which are herein incorporated by reference. For example, the process for creating the polymeric transfer layer can generally include (1) providing a coating solution comprising radically curable prepolymers and solvent (optional); (2) supplying the solution to a coating device; (3) applying the coating solution to the release liner by one of many coating techniques; (4) substantially removing the solvent (optional) from coating; (5) polymerizing the material in the presence of a controlled amount of inhibitor gas (e.g., oxygen) to provide a structured surface; and (6) optionally post-processing the dried polymerized coating, for example, by additional thermal, visible, ultraviolet (UV), or e-beam curing.

Polymerizable material described herein comprises free radical curable prepolymers. Exemplary free radical curable prepolymers include monomers, oligomers, polymers and resins that will polymerize (cure) via radical polymerization. Suitable free radical curable prepolymers include (meth)acrylates, polyester (meth)acrylates, urethane (meth)acrylates, epoxy (meth)acrylates and polyether (meth)acrylates, silicone (meth)acrylates and fluorinated meth(acrylates).

Exemplary radically curable groups include (meth) acrylate groups, olefinic carbon-carbon double bonds, allyloxy groups, alpha-methyl styrene groups, styrene groups, (meth)acrylamide groups, vinyl ether groups, vinyl groups, allyl groups and combinations thereof. Typically the polymerizable material comprises free radical polymerizable groups. In some embodiments, polymerizable material comprises acrylate and methacrylate monomers, and in particular, multifunctional (meth)acrylate, difunctional (meth)acrylates, monofunctional (meth)acrylate, and combinations thereof.

In some exemplary embodiments, the polymerizable compositions include at least one monomeric or oligomeric multifunctional (meth)acrylate. Typically, the multifunctional (meth)acrylate is a tri(meth)acrylate and/or a tetra(meth)acrylate. In some embodiments, higher functionality monomeric and/or oligomeric (meth)acrylates may be employed. Mixtures of multifunctional (meth)acrylates may also be used.

Exemplary multifunctional (meth)acrylate monomers include polyol multi(meth)acrylates. Such compounds are typically prepared from aliphatic triols, and/or tetraols containing 3-10 carbon atoms. Examples of suitable multifunctional (meth)acrylates are trimethylolpropane triacrylate, di(trimethylolpropane) tetraacrylate, pentaerythritol tetraacrylate, pentaerythritol triacrylate, the corresponding methacrylates and the (meth)acrylates of alkoxylated (usually ethoxylated) derivatives of said polyols. Examples of multi-functional monomers include those available under the trade designations “SR-295,” “SR-444,” “SR-399,” “SR-355,” “SR494,” “SR-368” “SR-351,” “SR492”, “SR350,” “SR415,” “SR454,” “SR499,” “501,” “SR502,” and “SR9020” from Sartomer Co., Exton, Pa., and “PETA-K,” “PETIA.” and “TMPTA-N” from Surface Specialties, Smyrna, Ga. The multi-functional (meth)acrylate monomers may impart durability and hardness to the structured surface.

In some exemplary embodiments, the polymerizable compositions include at least one monomeric or oligomeric difunctional (meth)acrylate. Exemplary difunctional (meth)acrylate monomers include diol difunctional(meth)acrylates. Such compounds are typically prepared from aliphatic diols containing 2-10 carbon atoms. Examples of suitable difunctional (meth)acrylates are ethylene glycol diacrylate, 1,6-hexanediol diacrylate, 1,12-dodecanediol dimethacrylate, cyclohexane dimethanol diacrylate, 1,4 butanediol diacrylate, diethylene glycol diacrylate, diethylene glycol dimethacrylate, 1,6-hexanediol dimethacrylate, neopentyl glycol diacrylate, neopentyl glycol dimethacrylate, and dipropylene glycol diacrylate.

Difunctional (meth)acrylates from difunctional polyethers are also useful. Examples include polyethylenglycol di(meth) acrylates and polypropylene glycol di(meth)acrylates.

In some exemplary embodiments, the polymerizable compositions include at least one monomeric or oligomeric monofunctional (meth)acrylate. Exemplary monofunctional (meth)acrylates and other free radical curable monomers include styrene, alpha-methylstyrene, substituted styrene, vinyl esters, vinyl ethers, N-vinyl-2-pyrrolidone, (meth)acrylamide, N-substituted (meth)acrylamide, octyl (meth)acrylate, iso-octyl (meth)acrylate, nonylphenol ethoxylate (meth) acrylate, isononyl (meth)acrylate, isobornyl (meth)acrylate, 2-(2-ethoxy-ethoxy)ethyl (meth)acrylate, 2-ethylhexyl (meth)acrylate, lauryl (meth)acrylate, butanediol mono(meth) acrylate, beta-carboxyethyl (meth)acrylate, isobutyl (meth)acrylate, 2-hydroxyethyl (meth)acrylate, (meth)acrylonitrile, maleic anhydride, itaconic acid, isodecyl (meth) acrylate, dodecyl (meth)acrylate, n-butyl (meth)acrylate, methyl (meth) acrylate, hexyl (meth)acrylate, (meth)acrylic acid, N-vinylcaprolactam, stearyl (meth)acrylate, hydroxy functional polycapro-lactone ester (meth) acrylate, hydroxyethyl (meth)acrylate, hydroxymethyl (meth)acrylate, hydroxypropyl (meth)acrylate, hydroxyisopropyl (meth)acrylate, hydroxybutyl (meth)acrylate, hydroxyisobutyl (meth)acrylate, tetrahydrofurfuryl (meth)acrylate, and combinations thereof. The monofunctional (meth)acrylates are useful, for example, for adjusting the viscosity and functionality of the prepolymer composition.

Oligomeric materials are also useful in making the material comprising sub-micrometer particles described herein. The oligomeric material contributes bulk optical and durability properties to the cured composition. Representative difunctional oligomers include ethoxylated (30) bisphenol A diacrylate, polyethylene glycol (600) dimethacrylate, ethoxylated (2) bisphenol A dimethacrylate, ethoxylated (3) bisphenol A diacrylate, ethoxylated (4) bisphenol A dimethacrylate, ethoxylated (6) bisphenol A dimethacrylate, polyethylene glycol (600) diacrylate.

Typical useful difunctional oligomers and oligomeric blends include those available under the trade designations “CN-120”, “CN-104”, “CN-116”, “CN-117,” from Sartomer Co. and “EBECRYL 1608”, “EBECRYL 3201”, “EBECRYL 3700”, “EBECRYL 3701”, “EBECRYL 608” from Cytec Surface Specialties, Smyrna, Ga. Other useful oligomers and oligomeric blends include those available under the trade designations “CN-2304”, “CN-115”, “CN-118”, “CN-119”, “CN-970A60”, “CN-972”, “CN-973A80”, and “CN-975” from Sartomer Co and “EBECRYL 3200,” “EBECRYL 3701,” “EBECRYL 3302,” “EBECRYL 3605,” “EBECRYL 608”, from Cytec Surface Specialties.

The polymeric transfer layer can be made from functionalized polymeric materials such as weatherable polymeric materials, hydrophobic polymeric materials, hydrophilic polymeric materials, antistatic polymeric materials, antistaining polymeric materials, conductive polymeric materials for electromagnetic shielding, antimicrobial polymeric materials, shape memory polymeric materials or antiwearing polymeric materials. Functional hydrophilic or antistatic polymeric matrix comprises the hydrophilic acrylates such as hydroxyethyl methacrylate (HEMA), hydroxyethyl acrylate (HEA), poly(ethylene glycol) acrylates with different polyethylene glycol (PEG) molecular weights, and other hydrophilic acrylates (e.g., 3-hydroxy propyl acrylate, 3-hydroxy propyl methacrylate, 2-hydroxy-3-methacryloxy propyl acrylate, and 2-hydroxy-3-acryloxy propyl acrylate).

In some embodiments, solvent can be removed from the composition by drying, for example, at temperatures not exceeding the decomposition temperature of the radiation curable prepolymer.

Exemplary solvents include linear, branched, and cyclic hydrocarbons, alcohols, ketones, and ethers, including propylene glycol ethers (e.g., 1-methoxy-2-propanol), isopropyl alcohol, ethanol, toluene, ethyl acetate, 2-butanone, butyl acetate, methyl isobutyl ketone, methyl ethyl ketone, cyclohexanone, acetone, aromatic hydrocarbons, isophorone, butyrolactone, N-methylpyrrolidone, tetrahydrofuran, esters (e.g., lactates, acetates, propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate), iso-alkyl esters, isohexyl acetate, isoheptyl acetate, isooctyl acetate, isononyl acetate, isodecyl acetate, isododecyl acetate, isotridecyl acetate, and other iso-alkyl esters), water and combinations thereof.

The first solution may also include a chain transfer agent. The chain transfer agent is preferably soluble in the monomer mixture prior to polymerization. Examples of suitable chain transfer agents include triethyl silane and mercaptans.

In some embodiments, the polymerizable composition comprises a mixture of the above described prepolymers. Desirable properties of the radically curable composition typically include viscosity, functionality, surface tension, shrinkage and refractive index. Desirable properties of the cured composition include mechanical properties (e.g. modulus, strength, and hardness), thermal properties (e.g., glass transition temperature and melting point), and optical properties (e.g., transmission, refractive index, and haze).

The surface structure obtained has been observed to be influenced by the curable prepolymer composition. For example, different monomers result in different surface nanostructure when cured under the same conditions. The different surface structure can result, for example, in different % reflection, haze, and transmission.

The surface nanostructure obtained has been observed to be facilitated by the free radical curable prepolymer composition. For examples, incorporation of certain mono-, di-, and multi-meth(acrylates) can result in surface nanostructures that exhibit preferable coating properties (e.g., % reflection, haze, transmission, steel wool scratch resistance, etc.) when processed under the same conditions. Conversely, different ratios and/or different prepolymers can also result in an inability to form surface nanostructures under similar processing conditions.

Constituent proportions in the radically curable prepolymers can vary. The composition may depend, for example, on the desired coating surface properties, bulk properties, and the coating and curing conditions.

In some embodiments, the radically curable prepolymer is a hardcoat material.

In some embodiments, the polymeric transfer layer comprises sub-micrometer particles. The sub-micrometer particles can provide durability and/or surface structure to the polymeric transfer layer.

Sub-micrometer particles dispersed in the polymeric transfer layer have a largest dimension less than 1 micrometer. Sub-micrometer particles include sub-micrometer particles (e.g., nanospheres, and nanotubes). The sub-micrometer particles can be associated or unassociated or both. The sub-micrometer particles can have spherical, or various other shapes. For example, sub-micrometer particles can be elongated and have a range of aspect ratios. In some embodiments, the sub-micrometer particles can be inorganic sub-micrometer particles, organic (e.g., polymeric) sub-micrometer particles, or a combination of organic and inorganic sub-micrometer particles. In one exemplary embodiment, sub micrometer particles can be porous particles, hollow particles, solid particles, or a combination thereof.

In some embodiments, the sub-micrometer particles are in a range from 5 nm to 1000 nm (in some embodiments, 20 nm to 750 nm, 50 nm to 500 nm, 75 nm to 300 nm, or even 100 nm to 200 nm). Sub-micrometer particles have a mean diameter in the range from about 10 nm to about 1000 nm. The sub-micrometer (including nanometer sized) particles can comprise, for example, carbon, metals, metal oxides (e.g., SiO₂, ZrO₂, TiO₂, ZnO, magnesium silicate, indium tin oxide, and antimony tin oxide), carbides (e.g., SiC and WC), nitrides, borides, halides, fluorocarbon solids (e.g., poly(tetrafluoroethylene)), carbonates (e.g., calcium carbonate), and mixtures thereof. In some embodiments, sub-micrometer particles comprises at least one of SiO₂ particles, ZrO₂ particles, TiO₂ particles, ZnO particles, Al₂O₃ particles, calcium carbonate particles, magnesium silicate particles, indium tin oxide particles, antimony tin oxide particles, poly(tetrafluoroethylene) particles, or carbon particles. Metal oxide particles can be fully condensed. Metal oxide particles can be crystalline.

In some embodiments, the sub-micrometer particles have a multimodal distribution. In some embodiments, the sub-micrometer particles have a bimodal distribution.

Exemplary silicas are available, for example, from Nalco Chemical Co., Naperville, Ill., under the trade designation “NALCO COLLOIDAL SILICA,” such as products 2326, 2727, 2329, 2329K, and 2329 PLUS. Exemplary fumed silicas include those available, for example, from Evonik Degusa Co., Parsippany, N.J., under the trade designation, “AEROSIL series OX-50”, as well as product numbers-130, -150, and -200; and from Cabot Corp., Tuscola, Ill., under the designations “CAB-O-SPERSE 2095”, “CAB-O-SPERSE A105”, and “CAB-O-SIL M5”. Other exemplary colloidal silica are available, for example, from Nissan Chemicals under the designations “MP1040,” “MP2040,” “MP3040,” and “MP4540”.

In some embodiments, the sub-micrometer particles are surface modified. Preferably, the surface-treatment stabilizes the sub-micrometer particles so that the sub-micrometer particles are well dispersed in the polymerizable resin, and result in a substantially homogeneous composition. In some embodiments, the sub-micrometer particles can be modified over at least a portion of its surface with a surface treatment agent so that the stabilized sub-micrometer particles can copolymerize or react with the polymerizable resin during curing.

In some embodiments, the sub-micrometer particles are treated with a surface treatment agent. In general, a surface treatment agent has a first end that will attach to the particle surface (covalently, ionically or through strong physisorption) and a second end that imparts compatibility of the particle with the resin and/or reacts with the resin during curing. Examples of surface treatment agents include alcohols, amines, carboxylic acids, sulfonic acids, phosphonic acids, silanes, and titanates. The preferred type of treatment agent is determined, in part, by the chemical nature of the metal oxide surface. Silanes are preferred for silica and other siliceous particles. Silanes and carboxylic acids are preferred for metal oxides, such as zirconia.

The surface modification can be done either subsequent to mixing with the monomers or after mixing. It is preferred in the case of silanes to react the silanes with the sub-micrometer particles or sub-micrometer particle surface before incorporation into the resins. The required amount of surface modifier is dependent on several factors such as particle size, particle type, molecular weight of the modifier, and modifier type.

Exemplary embodiments of surface treatment agents that do not have radically copolymerizable groups include compounds such as isooctyl tri-methoxy-silane, N-(3-triethoxysilylpropyl)methoxyethoxy-ethoxyethyl carbamate, N-(3-triethoxysilylpropyl) methoxyethoxyethoxyethyl carbamate, pheyltrimethoxysilane, n-octyltrimethoxysilane, dodecyltrimethoxysilane, octadecyltrimethoxysilane, propyltrimethoxysilane, hexyltrimethoxy-silane, 3-glycidoxypropyltrimethoxysilane, oleic acid, stearic acid, dodecanoic acid, 2-(2-(2-methoxyethoxy)ethoxy)acetic acid (MEEAA), 2-(2-methoxyethoxy)acetic acid, methoxyphenyl acetic acid, and mixtures thereof. One exemplary silane surface modifier is available, for example, from Momentive Performance Materials, Wilton, Conn., under the trade designation “SILQUEST A1230”.

Exemplary embodiments of surface treatment agents that radically copolymerize with the curable resin include compounds 3-(methacryloyloxy)propyltrimethoxysilane, 3-acryloxy-propyltrimethoxysilane, 3-(methacryloyloxy)propyltriethoxysilane, 3-(methacryloyloxy)-propylmethyldimethoxysilane, 3-(acryloyloxypropyl)methyldimethoxysilane, 3-(methacryloyl-oxy)propyldimethylethoxysilane, vinyldimethylethoxysilane, vinylmethyldiactoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, acrylic acid, methacrylic acid, beta-carboxyethylacrylate, and mixtures thereof.

A variety of methods are available for modifying the surface of sub-micrometer particles including adding a surface modifying agent to sub-micrometer particles (e.g., in the form of a powder or a colloidal dispersion) and allowing the surface modifying agent to react with the sub-micrometer particles. Other useful surface modification processes are described, for example, in U.S. Pat. No. 2,801,185 (Iler) and U.S. Pat. No. 4,522,958 (Das et al.).

Surface modification of the sub-micrometer particles in the colloidal dispersion can be accomplished in a variety of ways. Typically the process involves the mixture of an inorganic dispersion with surface modifying agents. Optionally, a co-solvent can be added at this point (e.g., 1-methoxy-2-propanol, ethanol, isopropanol, ethylene glycol, N,N-dimethylacetamide, and 1-methyl-2-pyrrolidinone). The co-solvent can enhance the solubility of the surface modifying agents as well as the dispersion of the surface modified sub-micrometer particles. The mixture comprising the inorganic dispersion and surface modifying agents is subsequently reacted at room or an elevated temperature, with or without mixing In one exemplary method, the mixture can be reacted at about 85-100° C. for about 16 hours, resulting in the surface modified dispersion. In another exemplary method, where metal oxides are surface modified, the surface treatment of the metal oxide can involve the adsorption of acidic molecules to the particle surface. Surface modification of the heavy metal oxide preferably takes place at room temperature.

Surface modification of ZrO₂ with silanes can be accomplished under acidic conditions or basic conditions. In one example, the silanes are heated under acid conditions for a suitable period of time. At which time the dispersion is combined with aqueous ammonia (or other base). This method allows removal of the acid counter ion from the ZrO₂ surface as well as reaction with the silane. In another exemplary method, the sub-micrometer particles are precipitated from the dispersion and separated from the liquid phase.

The surface modified sub-micrometer particles can then be incorporated into the radically curable prepolymer in various methods. In some embodiments, a solvent exchange procedure is utilized whereby the resin is added to the surface modified dispersion, followed by removal of the water and co-solvent (if used) via evaporation, thus leaving the surface modified sub-micrometer particles dispersed in the radically curable prepolymer. The evaporation step can be accomplished for example, via distillation, rotary evaporation or oven drying.

In some embodiments, the surface modified sub-micrometer particles can be extracted into a water immiscible solvent followed by solvent exchange, if so desired.

Another exemplary method for incorporating the surface modified sub-micrometer particles in the radically curable prepolymer involves the drying of the surface modified sub-micrometer particles into a powder, followed by the addition of the radically curable prepolymer material into which the sub-micrometer particles are dispersed. The drying step in this method can be accomplished by conventional means suitable for the system (e.g., oven drying, gap drying, spray drying, and rotary evaporation).

In some embodiments the coating solution is produced by combining radically curable prepolymer and surface modified sub-micrometer particles with a solvent or solvent mixture. The coating solution facilitates the coating of the radically curable composition.

A coating solution can be obtained, for example, by adding the desired coating solvents to a radically curable prepolymer and sub-micrometer particle composition prepared as described above.

In one exemplary embodiment a coating solution can be prepared by solvent exchange of the surface modified sub-micrometer particles into the coating solvent, followed by addition of the radically curable prepolymer.

In another exemplary embodiment a coating solution can be prepared by drying the surface modified sub-micrometer particles into a powder. The powder is then dispersed in the desired coating solvent. The drying step in this method can be accomplished by conventional means suitable for the system (e.g., oven drying, gap drying, spray drying, and rotary evaporation). The dispersion can be facilitated, for example, by mixing sonication, milling, and microfluidizing.

The surface modifiers have been observed to influence the surface structure obtained. Further, the sub-micrometer particle surface modifiers have been observed to influence the coating bulk properties and surface structure. The surface modifiers can be used to adjust the compatibility of the sub-micrometer particles with the radically curable prepolymer and the solvent system. This has been observed to affect, for example, the clarity and the viscosity of the radiation curable composition. In addition, the ability of the modified sub-micrometer particle to cure into the polymer coating has been observed to affect the rheology of the first region during cure. The viscosity and gel point affect the surface structure obtained.

In some embodiments, a combination of surface modifying agents may be useful. In some embodiments, a combination of surface modifying agents may be useful, for example, wherein at least one of the agents has a functional group co-polymerizable with a radically curable prepolymer. Useful ratios of radically polymerizable and non-radically polymerizable include 100:0, thru 0:100. An exemplary combination of radically polymerizable and non-radically polymerizable surface modifiers is 3-(methacryloyloxy)propyltrimethoxysilane (MPS) and a silane surface modifier available, for example, from Momentive Performance Materials, under the trade designation “SILQUEST A1230. Exemplary surface modifier combinations include MPS:A1230 with molar ratios of 100:0, 75:25, 50:50, and 25:75.

The weight ratio of the sub-micrometer particles to radically curable prepolymers has been observed to influence the surface structure. The surface structure can be formed at ratios below the critical binder concentration. That is, binder lean compositions are not needed to obtain the surface structure. This allows greater latitude in formulation and also gives greater durability over the systems where the polymer binder is limited. This also has been observed to allow easy access to a range of coating thicknesses.

The surface nanostructure obtained has been observed to be affected by the weight ratio of sub-micrometer particles to radical curable prepolymer in the composition. For example, adjusting the weight ratio (e.g., 10:90, 30:70, 50:50, 70:30, etc.) may result in surface nanostructures that exhibit preferable coating properties (e.g., % reflection, haze, transmission, steel wool scratch resistance, surface roughness, etc.) when processed under the same conditions.

The weight ratio of surface modified sub-micrometer silica particles to radically curable prepolymer is a measure of the particle loading. Typically, surface modified sub-micrometer particles are present in the polymeric transfer layer in an amount in a range from about 10:90 to 80:20 (in some embodiments, for example, 20:80 to 70:30).

The curable prepolymer compositions are polymerizable using conventional techniques such as thermal cure, photocure (cure by actinic radiation), or e-beam cure. In one exemplary embodiment, the resin is photopolymerized by exposing it to ultraviolet (UV) or visible light. Conventional curatives or catalysts may be used in the polymerizable compositions, and selected based on the functional group(s) in the composition. Multiple curatives or catalysts may be needed if multiple cure functionality is being used. Combining one or more cure techniques, such as thermal cure, photocure, and e-beam cure, is within the scope of the present disclosure.

An initiator, such as a photoinitiator, can be used in an amount effective to facilitate polymerization of the prepolymers present in the second solution. The amount of photoinitiator can vary depending upon, for example, the type of initiator, the molecular weight of the initiator, the intended application of the resulting nanostructured material and the polymerization process including, the temperature of the process and the wavelength of the actinic radiation used. Useful photoinitiators include, for example, those available from Ciba Specialty Chemicals under the trade designations “IRGACURE” and “DAROCURE”, including “IRGACURE 184” and “IRGACURE 819,” respectively.

In some embodiments, a mixture of initiators and initiator types can be used, for example, to control the polymerization in different sections of the process. In one embodiment, optional post-processing polymerization may be a thermally initiated polymerization that requires a thermally generated free-radical initiator. In other embodiments, optional post-processing polymerization may be an actinic radiation initiated polymerization that requires a photoinitiator. The post-processing photoinitiator may be the same or different than the photoinitiator used to polymerize the polymer in solution.

The photoinitiator concentration has been observed to have an influence on the surface structure of the coating. The photoinitiator has been observed to affect the rate of polymerization. The time required to reach the gel point and corresponding increase in viscosity of this first region is affected. In some embodiments photoinitiator concentration is in a range from 0.25-10 wt. % of total solids (in some embodiments, 0.5-5 wt. %, or even 1-4 wt. %).

The surface nanostructure has been observed to be facilitated by the amount of photoinitiator added to the free radical curable prepolymer composition. For example, incorporation of different amounts of photoinitiator can result in surface nanostructures that exhibit preferable coating properties (e.g., % reflection, haze, transmission, steel wool scratch resistance, etc.) when processed under the same conditions.

The method for forming surface nanostructure has been observed to be facilitated by the amount of photoinitiator added to the free radical curable prepolymer composition. For example, incorporation of different amounts of photoinitiator can result in surface nanostructures that exhibit preferable processing conditions (e.g., web speed, inhibition gas concentration, actinic radiation, etc.).

Surface leveling agents may be added to the material (solution). The leveling agent is preferably used for smoothing the polymeric transfer layer. Examples include silicone-leveling agents, acrylic-leveling agents and fluorine-containing-leveling agents. In one exemplary embodiment, the silicone-leveling agent includes a polydimethyl siloxane backbone to which polyoxyalkylene groups are added.

The surface nanostructure obtained has been observed to be facilitated by additives to the free radical curable prepolymer composition. For example, incorporation of certain low surface energy materials can result in surface nanostructures that exhibit preferable coating properties (e.g., % reflection, haze, transmission, steel wool scratch resistance, etc.).

In some embodiments, low surface energy additives (e.g., that available under the trade designation “TEGORAD 2250” from Evonik Goldschimdt Corporation, Hopewell, Va. and a perfluoropolyether containing copolymer (HFPO) prepared as Copolymer B in U.S. Pat. Pub. No. 2010/0310875 A1 (Hao et. al.)) may be added, for example, in a range from 0.01 wt. % to 5 wt. % (in some embodiments, 0.05 wt. % to 1 wt. %, or even 0.01 wt. % to 1 wt. %).

It is desirable that the polymeric transfer layer result in a defect-free coating. In some embodiments, defects that can manifest during the coating process may include optical quality, haze, roughness, wrinkling, dimpling, dewetting, etc. These defects can be minimized with employment of surface leveling agents. Exemplary leveling agents include those available under the trade designation “TEGORAD” from Evonik Goldschimdt Corporation. Surfactants such as fluorosurfactants can be included in the polymerizable composition, for example, to reduce surface tension, improve wetting, allowing smoother coating, and fewer coating defects.

### Release Liner

The polymeric transfer layer can be coated onto a release liner. In some embodiments, the release liner comprises a release material on PET film. The appropriate release coating will depend upon the polymeric transfer layer utilized. As mentioned above, the polymeric transfer layer should adequately adhere to the release liner so that the liner remains in place during processing and transport of the barrier composite, yet cleanly transfer off (i.e., release from) the release liner when the liner is intentionally removed.

Useful release liners are described, for example, in U.S. Patent Application Pub. No. 2009/0000727 (Kumar et al.), which in herein incorporated by reference. Such release liners comprise a release material that can be formed by irradiating (for example, by using an UV ray or electron beam) a release materiel precursor having shear storage modulus of about 1×10² Pa to about 3×10⁶ Pa at 20° C. and a frequency of 1 Hz. The release material (after irradiation) has a contact angle of 15° or more, measured using a mixed solution of methanol and water (volume ratio 90:10) having a wet tension of 25.4 mN/m. Examples of suitable release material precursors include polymers having a shear storage modulus within the above-described range, such as, for example, a poly(meth)acrylic ester, a polyolefin, or a polyvinyl ether.

An example of a useful release material precursor is a copolymer having two kinds of acryl monomer components such as, for example, a (meth)acrylate containing an alkyl group having from about 12 to about 30 carbon atoms (hereinafter referred to as a “first alkyl (meth)acrylate”) and a (meth)acrylate containing an alkyl group having from 1 to about 12 carbon atoms (hereinafter referred to as a “second alkyl (meth)acrylate”).

The first alkyl (meth)acrylate contains a relatively long alkyl side chain having from about 12 to about 30 carbon atoms that helps to decrease the surface energy of the release material. Accordingly, the first alkyl (meth)acrylate acts to impart a low release strength to the release material. The first alkyl (meth)acrylate typically does not contain a polar group (for example, a carboxyl group, a hydroxyl group, or a nitrogen- or phosphorous-containing polar group) on the side chain. Accordingly, the first alkyl (meth)acrylate can impart relatively low release strength to the release material, not only at low temperatures, but also even after exposure to relatively high temperatures.

Preferred examples of the first alkyl (meth)acrylate having a long chain alkyl group include lauryl (meth)acrylate, cetyl (meth)acrylate, (iso)octadecyl (meth)acrylate, and behenyl (meth)acrylate. The first alkyl (meth)acrylate is typically present in an amount of about 10% to about 90% by weight based on the total amount of the first alkyl (meth)acrylate and the second alkyl (meth)acrylate.

The second alkyl (meth)acrylate contains a relatively short alkyl side chain having from 1 to about 12 carbon atoms. This relatively short alkyl side chain decreases the glass transition temperature of the release material to about 30° C. or less. In turn, the release material precursor is reduced in crystallinity and also in the shear storage modulus.

In one embodiment, the second alkyl (meth)acrylate containing an alkyl group having 12 carbon atoms is the same as the first alkyl (meth)acrylate having 12 carbon atoms. In this case, unless other components are present, the release material can be formed from a release material precursor containing a homopolymer.

Furthermore, the second alkyl (meth)acrylate typically does not contain a polar group on the side. Therefore, similarly to the first alkyl (meth)acrylate, the second alkyl (meth)acrylate imparts a relatively low release strength, not only at a low temperature, but also at a relatively high temperature.

Preferred examples of the second (meth)acrylate having a short chain alkyl group include butyl (meth)acrylate, hexyl (meth)acrylate, octyl (meth)acrylate, and lauryl (meth)acrylate. The second alkyl (meth)acrylate is typically present in an amount of about 10% to about 90% by weight based on the total amount of the first alkyl (meth)acrylate and the second alkyl (meth)acrylate.

The first and/or the second alkyl (meth)acrylates may be a (meth)acrylate having a branched side chain such as 2-heptylundecyl acrylate, 2-ethylhexyl (meth)acrylate, or isononyl (meth)acrylate. (Meth)acrylates having a branched side chain reduce the crystallinity and therefore decrease the shear storage modulus and the surface energy. A homopolymer consisting of a monomer component of alkyl (meth)acrylate containing a branched alkyl group having from about 8 to about 30 carbon atoms can be useful as the release material precursor. For example, a homopolymer of 2-heptylundecyl acrylate is a preferred release material precursor from the standpoint that the obtained release material can be reduced in surface energy and shear storage modulus. A copolymer comprising a monomer component of alkyl (meth)acrylate containing a straight alkyl group and a monomer component of alkyl (meth) acrylate containing a branched alkyl group having from about 8 to about 30 carbon atoms can also be useful as the release material precursor. For example, a copolymer of stearyl acrylate and isostearyl acrylate is also a preferred release material precursor from the standpoint that the obtained release material can be reduced in surface energy and shear storage modulus.

Preferred release material precursors can be obtained by polymerization of alkyl (meth)acrylates in the presence of a polymerization initiator. The polymerization initiator is not particularly limited as long as it can bring about the polymerization. Examples of useful polymerization initiators include azobis compounds such as 2,2′-azobisisobutyronitrile, 2,2′-azobis(2-methylbutylonitrile), and 2,2′-azobis(2-methylvaleronitrile and peroxides such as benzoyl peroxide and lauroyl peroxide. Some polymerization initiators are commercially available, such as 2,2′-azobisisobutyronitrile and 2,2′-azobis(2-methylbutylonitrile), which are available as V-60 and V-59 from Wako Pure Chemical Industries, Ltd. (Osaka, Japan). The amount of polymerization initiator can vary, but the polymerization initiator is typically used in an amount of about 0.005% to about 0.5% by weight based on the weight of the monomer.

The polymerization of the above-described alkyl (meth)acrylates can be performed by any known method. For example, a solution polymerization method, which involves dissolving the alkyl (meth)acrylates in a solvent and polymerizing them in solution can be used. The polymer solution can be directly taken out and used after the completion of polymerization. In this case, the solvent to be used is not particularly limited. Some examples of suitable solvents include ethyl acetate, methyl ethyl ketone, and heptane. A chain transfer agent can also be incorporated into the solvent in order to control molecular weight. The solution polymerization of the polymerizable composition can typically be performed at a reaction temperature of about 50° C. to about 100° C. for about 3 to about 24 hours in an atmosphere of an inert gas such as nitrogen.

When the release material precursor is a poly(meth)acrylate, the release material polymer typically has a weight average molecular weight of about 100,000 to about 2,000,000. If the weight average molecular weight is less than about 100,000, the release strength may increase, whereas if the weight molecular average molecular weight exceeds about 2,000,000, the viscosity of the polymer solution may be increased during synthesis, making handling of the polymer solution relatively difficult.

As long as the above-described physical properties can be attained, the release material can be constituted by a polyolefin. The polyolefin can be formed from an olefin monomer having from about 2 to about 12 carbon atoms. Examples of useful olefin monomers include linear olefins such as ethylene, propylene, 1-butene, 1-pentene, 1-hexene, 1-heptene, 1-octene, 1-nonene, 1-decene, 1-undecene, 1-dodecene, and branched olefins such as 4-methyl-1-pentene, 5-methyl-1-hexene, 4-methyl-1-hexene, 7-methyl-1-octene, and 8-methyl-1-nonene. However, a homopolymer of ethylene or propylene, namely polyethylene and polypropylene, generally cannot satisfy the physical properties of shear storage modulus because of their crystallinity. Therefore, when using ethylene, propylene, or the like, the shear storage modulus is typically decreased by copolymerization, for example, with 1-butene, 1-octene, or the like.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. Polyolefins having a high molecular weight can be produced by conventionally known polymerization methods such as, for example, ionic polymerization, preferably coordinated anionic polymerization.

Examples of useful commercially available polyolefins include ethylene/propylene copolymers are available from JSR Corporation (Tokyo, Japan) as EP01P and EP912P, and an ethylene/octene copolymer available from The Dow Chemical as Engage™ 8407.

The release material precursor can also be a polyvinyl ether having the above-described properties. Examples of the starting monomer for a polyvinyl ether include linear or branched vinyl ethers such as n-butyl vinyl ether, 2-hexyl vinyl ether, dodecyl vinyl ether, and octadecyl vinyl ether. However, for example, polyoctadecyl vinyl ether does not satisfy the above-described physical properties for the shear storage modulus. Therefore, when using octadecyl vinyl ether, the shear storage modulus is typically decreased by copolymerization, for example, 2-ethylhexyl vinyl ether.

With respect to the copolymer structure, a random copolymer is preferred from the standpoint of reducing crystallinity. However, even if the copolymer has crystallinity, as long as the shear storage modulus is acceptable, a block copolymer can be used. The weight average molecular weight is typically from about 100,000 to about 2,000,000. The polyvinyl ether can be produced by ionic polymerization such as, for example, by cationic polymerization.

The release material precursor can be provided on a liner substrate, preferably a liner substrate comprising polyester, polyolefin, or paper. The release material precursor can then be subjected to a treatment of radiation, for example, by using an electron beam or UV rays. The release material precursor generally has no polar functional groups such as carboxyl groups, hydroxyl groups, or amide groups. Therefore, it would be expected that the release material precursor would exhibit poor anchoring to the liner substrate. However, despite the absence of a polar functional group in the release material precursor, the anchoring between the liner substrate and the release material can be increased by treatment with radiation.

The release liner can be manufactured as follows. A solution of the release material precursor can be diluted with a diluent, for example, containing at least one of ethyl acetate, butyl acetate, methyl ethyl ketone, methyl isobutyl ketone, hexane, heptane, toluene, xylene, and methylene chloride, and then coated to a predetermined thickness, thereby forming a release material precursor layer on the liner substrate. The diluent can be the same as or different than the solvent used in the solution polymerization.

Examples of liner substrates that can be used include plastics such as polyesters (for example, a polyethylene terephthalate, polyethylene naphthalate, or polybutylene terephthalate film) and polyolefins, and paper. The thickness of the release material precursor depends on the type of liner substrate but is generally from about 0.01 to about 1 μm (preferably, from about 0.05 to about 0.5 μm).

The release material precursor can be irradiated by, for example, an electron beam or ultraviolet ray. In the case of using an electron beam, the irradiation is typically performed under an inert gas such as nitrogen. The absorbed dose thereto depends on the thickness and composition of the release material precursor layer and is usually from about 1 to about 100 kGy. If an ultraviolet ray is used, the irradiation energy of the release material precursor layer is usually from about 10 to about 300 mJ/cm² (preferably, from about 20 to about 150 mJ/cm²).

An example of another useful release material precursor is an acrylic release agent precursor which comprises a poly(meth)acrylate ester having a group capable of being activated by ultraviolet radiation (also referred to as “an ultraviolet active group”) and has a shear storage modulus of about 1×10² to about 3×10⁶ Pa at 20° C. and a frequency of 1 Hz. The acrylic release agent precursor, after irradiation with ultraviolet radiation, has a contact angle of about 15° or more to a mixed solution of methanol and water (volume ration of 90:10) having a wetting tension of 25.4 mN/m.

The acrylic release agent precursor can be a polymer composition comprising a polymer such as poly(meth)acrylate ester having an ultraviolet active group. The poly(meth)acrylate is, for example, a copolymer formed from a first alkyl (meth)acrylate as described above, a second alkyl (meth)acrylate as described above, and a (meth)acrylate ester having an ultraviolet active group.

Preferred first alkyl (meth)acrylates containing a long alkyl side chain for the acrylic release agent precursor include lauryl (meth)acrylate, cetyl (meth)acrylate, stearyl (meth)acrylate, and behenyl (meth)acrylate.

The copolymer typically contains the first alkyl (meth)acrylate or second alkyl (meth)acrylate in an amount from about 10 to about 90% by weight based on the total weight of the first and second alkyl (meth)acrylates.

The poly (meth)acrylate ester can also be derived from a monomer component containing an alkyl (meth)acrylate having a branched alkyl group having from about 8 to about 30 carbon atoms and a (meth)acrylate ester having an ultraviolet active group. Examples of suitable alkyl (meth)acrylate having a branched alkyl group include 2-ethylhexyl (meth)acrylate, 2-hexyldodecyl acrylate, 2-heptylundecyl acrylate, 2-octyldecyl acrylate, and isononyl (meth)acrylate.

Such a (meth)acrylate having a branched side chain can reduce the shear storage modulus and surface energy by lowering the crystallinity. Thus, it is not necessary for the acrylic release agent precursor to contain two components such as a first alkyl (meth)acrylate and a second alkyl (meth)acrylate described above if it has a branched alkyl group having from about 8 to about 30 carbon atoms. For example, the polymer of 2-hexyldecyl acrylate or 2-octyldecyl acrylate can reduce the surface energy of the release agent.

Typically, the monomer component has no polar groups on the side chain. However, the monomer component may, for example, have a polar functional group on the side chain as long as the acrylic release agent precursor has a shear storage modulus as described above.

The poly(meth)acrylate ester has an ultraviolet active group. This ultraviolet active group can generate a free radical in the acrylic release agent precursor by irradiation with ultraviolet radiation. The generated free radical promotes crosslinking of the acrylic release agent precursor and adhesion to the liner substrate, resulting in an improvement in adhesion between the liner substrate and the release agent. Preferably, the amount of the (meth)acrylate ester having an ultraviolet active group is within a range of about 0.01 to about 1% by weight per poly(meth)acrylate ester unit.

The ultraviolet active group is not specifically limited, but is preferably derived from benzophenone or acetophenone. Introduction of the ultraviolet active group into the poly(meth)acrylate ester can be conducted by incorporating a (meth)acrylate ester having an ultraviolet active group as a monomer component and polymerizing the monomer component containing the (meth)acrylate ester.

The polymer of the acrylic release agent precursor preferably has a weight-average molecular weight within a range from about 100,000 to about 2,000,000.

The monomer component described above can be polymerized in the presence of a polymerization initiator to form an acrylic release agent precursor. Preferably, the polymerization is solution polymerization. Solution polymerization can typically be conducted in the state where the monomer component is dissolved in a solvent, together with the polymerization initiator, in an atmosphere of an inert gas such as nitrogen at about 50° to about 100° C. Solvents such as, for example, ethyl acetate, methyl ethyl ketone, or heptane can be used. Optionally, the molecular weight of the polymer can be controlled by adding a chain transfer agent to the solvent.

The polymerization initiator is not specifically limited. For example, an azobis compound such as 2,2′-azobisisobutyronitrile, 2,2′-azobis(2-methylbutyronitrile) or 2,2′-azobis(2,4-dimethylvaleronitrile), dimethyl 2,2′-azobis(2-methylpropionate) and a peroxide such as benzoyl peroxide or lauroyl peroxide can be used as the polymerization initiator. Preferably, the polymerization initiator is used in the amount within a range from 0.005 to 0.5% by weight based on the total weight of the monomer component.

The acrylic release agent precursor as described above is converted into an acrylic release agent by irradiating with ultraviolet radiation, after the precursor is coated on a liner substrate. Typically, the acrylic release agent is formed on the liner substrate in the thickness within a range from 0.01 to 1 μm. The acrylic release agent is generally obtained by irradiating with ultraviolet radiation after coating with the acrylic release agent precursor. As disclosed in WO 01/64805 and/or KOKAI (Japanese Unexamined Patent Publication) No. 2001-240775, the acrylic release agent adheres to the liner substrate by the irradiation with ultraviolet radiation, even though the acrylic release agent typically has no polar functional group. The liner substrate can be, for example, a film made of plastic such as polyester or polyolefin (for example, polyethylene terephthalate, polyethylene naphthalate or polybutylene terephthalate) or a paper. Preferred thickness of the liner substrate is within a range from about 10 to about 300 μm.

Usually, the acrylic release agent precursor is produced by solution polymerization as described above and exists in the state of a polymer solution. Therefore, the liner substrate can be coated with the polymer solution in a thickness typically within a range from about 0.01 to about 1 μm (preferably from 0.05 to 0.5 μm), using coating means such as bar coater. If necessary, the polymer solution can be applied after diluting with a diluent until a predetermined viscosity is achieved. Examples of the diluent include ethyl acetate, butyl acetate, methyl ethyl ketone, methyl isobutyl ketone, hexane, heptane, toluene, xylene, and methylene chloride.

The acrylic release agent precursor applied as described above is converted into an acrylic release agent by irradiation with ultraviolet radiation. The dose of irradiation with ultraviolet radiation varies depending on the kind and structure of the poly(meth)acrylate, but can usually be a low dose within a range from 10 to 150 mJ/cm².

### Barrier Composites

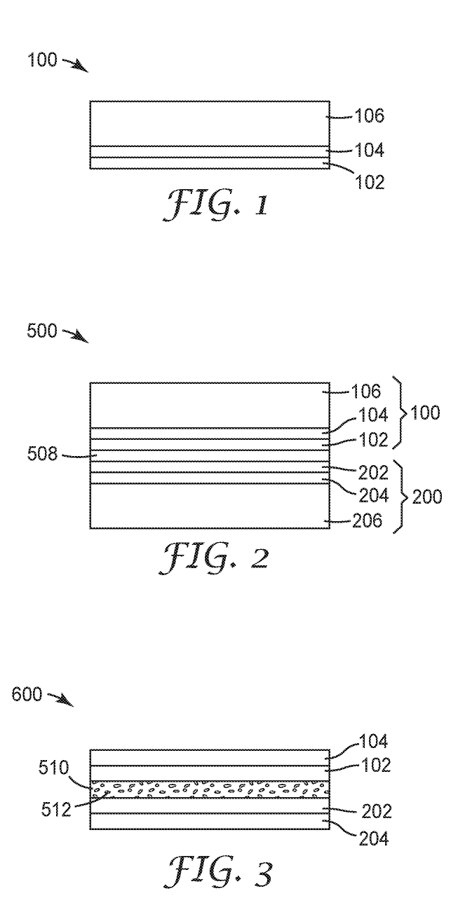

The barrier composites of the invention can be used as a substrate-less barrier to protect thin-film organic and inorganic devices from moisture and oxygen. For example, as illustrated in FIG. 1, barrier composite 100 comprising gas-barrier film 102, polymeric transfer layer 104 and release liner 106 can be transferred and adhered to, for example, a another film, glass, or an opto-electronic device such as an OLED.

Double barrier composites such as the double barrier composite illustrated in FIG. 2 can also be utilized. Double barrier composite 500 comprises (a) first barrier composite 100 comprising first gas-barrier film 102 disposed on first polymeric transfer layer 104, (b) second barrier composite 200 comprising second gas-barrier film 202 disposed on second polymeric transfer layer 204 and (c) a layer comprising a cross-linked polymer layer 508 disposed between first gas-barrier film 102 and second gas-barrier film 202. Double barrier composites can optionally have release liners (106, 206), such as those described above, on either or both polymeric transfer layers.

The cross-linked polymer layer can be, for example, a UV, thermal or otherwise cross-linkable polymeric material comprising a thiol-ene, (meth)acrylate, epoxy or other optically clear polymerizable system. In some embodiments, the cross-linked polymeric layer has a Tg of about 10° C. or greater. In some embodiments, the cross-linked polymeric layer has a shear modulus of about 100 kPa or greater. In some embodiments, the cross-lined polymer layer has a thickness of about 2 microns to about 200 microns, or about 2 microns to about 100 microns.

Useful materials for the cross-linked polymer layer are described, for example, in co-pending applications 62/232,071 (Eckert et al.), 62/256,764 (Chakraborty et al.), 62/148,212 (Qiu et al.), 62/195,434 (Qiu et al.), 62/080,488 (Qiu et al.) and 62/148,212 (Qiu et al.), which are herein incorporated by reference.

A useful material for the cross-linked polymer layer can be formed from a blend of urethane acrylate oligomer and acrylate monomer with photoinitiator. In some embodiments the blend is approximately 65:35 urethane acrylate oligomer:acrylate monomer.

In some embodiments, such as the embodiment illustrated in FIG. 3, the cross-linked polymer layer 510 comprises a moisture and oxygen sensitive material such as, for example, quantum dots 512. Currently, quantum dot film constructions comprise a quantum dot matrix layer between two PET films coated with barrier layers. The substrate-less barrier composites of the present invention provide substantially (e.g., 50%) thinner quantum dot article. In addition, the quantum dot articles of the invention are more efficient for light output than conventional quantum dot film constructions having the same quantum dot matrix thickness.

In some embodiments, the cross-linked polymer layer comprises one or more of the following: conductive particles such as silver nano-wires or carbon nano-tubes, desiccant nanoparticles, getter nanoparticles, nanoparticles of varying sizes and compositions (as described above), UV blocking molecules, UV stabilizing molecules such as hindered amine light stabilizers (HALS) or non-HALS, light diffusing nanoparticles, chemical dyes to alter optical effects such as color or light absorption, and the like.

The barrier composites of the invention can be transferred to another film, substrate or opto-electronic device using an adhesive. For example, the barrier composites can be transferred to substrates including touch sensors, silver nanowires, transparent conductive oxides, polarizers, heat stabilized substrates, cover window films, thin film devices and the like. Any useful adhesive having appropriate optical properties (e.g., optically clear) for the end use may be utilized. For example, a hot melt adhesive, UV-cured adhesive, pressure sensitive adhesive (PSA), thermoset adhesive, thermoplastic or barrier adhesive can be utilized.

Useful barrier adhesives include adhesive compositions comprising polyisobutylene resins such as those described in U.S. Pat. No. 8,232,350 (Fujita et al.) and co-pending application 62/206,044 (Johnson et al.).

Examples of useful adhesive include PSAs made from acrylates such as 3M Ultra-Clean Laminating Adhesive 501FL and Optically Clear Adhesive 8141, both available from 3M Company (St. Paul, Minn.), rubbers such as KRATON styrenic block copolymers from Kraton Corporation (Houston, Tex.), silicones such as RHODOTAK 343 from Rhodia Silicones (Lyon, France), and polyolefins such as poly(1-hexene), poly(1-octene), and poly(4-ethyl-1-octene) described in U.S. Pat. No. 5,112,882 (Babu et al.); hot melt adhesives such as unloaded versions of the tackified polyamide-polyether copolymers described in U.S. Pat. No. 5,672,400 (Hansen et al.) and the thermoplastic polymer adhesive films described in U.S. Pat. No. 5,061,549; curable adhesives, thermosets, and crosslinking systems such as the unloaded versions of the epoxy/thermoplastic blends described in U.S. Pat. No. 5,362,421; the cyanate ester/ethylenically unsaturated semi-IPNs described in U.S. Pat. No. 5,744,557 (McCormick et al.); and the epoxy/acrylate compositions described in WO 97/43352. Various combinations of pressure sensitive adhesive, hot melt, and curable adhesives may be useful in the practice of the invention.

The barrier composites of the invention are particularly well-suited for protecting OLEDs because they do not comprise PET, which has an inherently high refractive index (i.e., n>1.6), light absorption at short wavelengths and birefringent properties, which compromise an OLED's performance. The barrier composites of the invention are thin and flexible. In some embodiments, barrier composites of the invention do not show barrier failure at a tensile strain or 1%, at a tensile strain of 2% or even at a tensile strain of 3%. In some embodiments, barrier composites of the invention do not show barrier failure after 100,000 cycles at a tensile strain of 1% or even at a tensile strain of 2%. Each component of the barrier composites of the invention has a refractive index of less than about 1.65, optical transmission between 400 nm to 700 nm of greater than about 88% and is non-birefringent. As used herein, “non-birefringent” means that birefringence is not observed in the barrier stack as it is used to protect a thin film device.

### Encapsulated Thin Film Devices

The barrier composites of the invention can be used to protect thin film devices from oxygen and moisture. Exemplary thin film devices include OLED displays and solid state lighting, solar cells, electrophoretic and electrochromic displays, thin film batteries, quantum dot devices, sensor and other organic electronic devices. The barrier composites are especially well-suited for applications that require oxygen and moisture protection as well as flexibility and high optical transmittance.

The barrier composites of the invention can be transferred onto an opto-electronic device to provide a “substrate-less” barrier for protection from moisture oxygen. The barrier composites can thus be used to produce thinner opto-electronic devices without compromising performance. In some embodiments, barrier composites of the invention are less than about 50 microns, less than about 25 microns or even less than about 10 microns thick. The barrier composites can be used to produce encapsulated thin film opto-electronic devices having thicknesses of less than about 200 microns, less than about 100 microns or even less than about 50 microns. In some embodiments, the encapsulated thin film device is about 10 microns to about 200 microns thick, or about 20 microns to about 120 microns thick, or even about 60 microns to about 90 microns thick.

As discussed above, the barrier composites of the invention are particularly well-suited for protecting OLEDs. The present invention can be applied to a flexible OLED to replace some or all the thin film encapsulation layers that are typically deposited directly onto the flexible OLED device. Current manufacturing process for encapsulating a flexible OLED follows the process described below.

A first thin film barrier layer composed of oxides, nitrides, or oxy nitride of a silicon or aluminum is deposited either by sputter deposition or by plasma enhanced chemical vapor deposition (CVD) processes onto the top of the OLED in a vacuum. The intermediate single barrier layer encapsulated flexible OLED is then transported out of vacuum and into a region of space that is separated from atmosphere where water vapor and oxygen are controlled to very low levels by purging a continuous flow of dry nitrogen gas. The intermediate thin film encapsulated OLED is then positioned under a bank of inkjet print heads and a layer of ultra violet radiation cured acrylate monomer and photo-initiator is applied to the top of the first thin film barrier. The intermediately encapsulated flexible OLED is then transported to a second environmentally controlled region and placed under a bank of ultra violet lamps and allowed to remain motionless for a predetermined amount of time to allow the liquid ink jetted acrylate material to level out to provide a highly smoothed surface prior to curing. Next, the acrylate monomer layer is cured in place by turning on the ultra-violet light. The intermediately encapsulated flexible OLED is then transported to a second vacuum chamber where a second oxide, nitride or oxy-nitride of silicon or aluminum is deposited by sputtering or plasma enhanced chemical vapor deposition to complete the encapsulation process. The thin film encapsulated OLED is then cycled to atmospheric pressure and transported to subsequent circular polarization and touch sensor lamination processes to complete the flexible OLED display.

The utility of transferring barrier layers of the present invention to other surfaces and substrates have been demonstrated by examples herein and leads to a simplified and less costly method of encapsulating a flexible OLED through the replacement of the two step inkjet and thin film deposition processes by a single lamination step. The replacement of the previous thin film encapsulation layers with transfer barrier layers enabled by this invention benefits flexible OLED makers in several ways. For example, the cost of encapsulation process can be lowered significantly by alleviating the need to buy additional expensive inkjet and plasma enhanced chemical vapor deposition tools. The transfer barrier lamination process also provides a path to reduce costs further by the lamination of transfer barrier to other functionalities such as light extraction, polarizing films and coatings, touch sensor films and flexible cover window films as a partially or fully integrated top side of an OLED. In addition, the transfer barrier composite can be directly processed via printing, solution coating or vapor deposition to gain other functionalities. The integration of other functionalities with a transferable barrier layer offers numerous alternatives to the OLED maker to stream line their panel making process.

### EXAMPLES

Objects and advantages of this invention are further illustrated by the following examples, but the particular materials and amounts thereof recited in these examples, as well as other conditions and details, should not be construed to unduly limit this invention.

### Materials Used

| Material | Description | Source |
|---|---|---|
| SR833M | Liquid Tricyclodecane dimethanol diacrylate | Sartomer USA, LLC, Exton, PA, |
| | | USA |
| Irgacure 184 | 1-hydroxycyclohexyl phenyl ketone | BASF Corporation, Tarrytown, |
| | | NY, USA |
| Dynasylan 1189 | N-(n-butyl)-3-aminoproyltrimethoxysilane | Evonik, Essen, DE |
| SiAl Rotary Target | 90% Si/10% Al targets | Soleras Advanced Coatings US, |
| | | Biddeford, ME, USA |
| NSNF release liner | Non-silicone non-fluorinated release liner | Described in US2009/0000727 |
| SR492 | Propoxylated (3) trimethylolpropane triacrylate | Sartomer USA, LLC, Exton, PA, |
| | | USA |
| SR238 | 1,6-hexanediol diacrylate | Sartomer USA, LLC, Exton, PA, |
| | | USA |
| 1-Methoxy-2-propanol | | |
| Tegorad 2250 | Silicone polyether acrylate | Evonik Goldschmidt Corp., |
| | | Hopewell, VA, USA |
| 100 nm silica particles | | Described below |
| Quantum dots | Red and Green CdSe quantum dots stabilized | Nanosys, Inc., Milpitas, California |
| | with amine-functionalized silicone | |
| TEMPIC | Tris[2-(3-mercaptopropionyloxy)ethyl] | Bruno Bock Chemische Fabrik |
| | Isocyanurate [CAS#36196-44-8] | GmbH & Co. KG, Marschacht, |
| | | Germany |
| TAIC | Triallyl Isocyanurate [CAS#36196-44-8] | TCI America, Portland, Oregon |
| TPO-L | Ethyl-2,4,6-trimethylbenzoylphenylphosphinate | BASF Corporation, Florham Park, |
| | | New Jersey |
| Barrier Film | FTB3-M-50 | 3M Company, St. Paul, MN |
| SR9003B | Propoxylated (2) neopentylglycol diacrylate | Sartomer USA, LLC, Exton, PA, |
| | | USA |
| CN991 | A proprietary aliphatic urethane acrylate | Sartomer USA, LLC, Exton, PA, |
| | oligomer, believed to be the reaction product of | USA |
| | H12MDI and SR495 | |
| CN929 | A proprietary trifunctional aliphatic urethane | Sartomer USA, LLC, Exton, PA, |
| | acrylate oligomer. | USA |
| SR506a | Isobornyl acrylate | Sartomer USA, LLC, Exton, PA, |
| | | USA |
| MEK | Methyl ethyl ketone | |
| IPA | Isopropyl alcohol | |

### Test Methods

### Moisture Barrier Performance

Moisture barrier performance was measured using a calcium corrosion test, as described below. First, a thick, opaque, reflective layer (about 100 nm thick) of metallic calcium was thermally evaporated onto a glass slide, within an inert environment to prevent premature corrosion. At the same time, a sheet of barrier adhesive was laminated to the barrier film stacks to provide test samples. Then, test samples with the adhesive were laminated to the calcium-coated glass slide. The slide was then exposed to a controlled environment having a temperature of 60° C. and a relative humidity (RH) of 90%. The slide was examined using a high resolution optical scanner at different points in time during the environmental exposure. As moisture penetrated the protective layers, it corroded the metallic calcium, converting the opaque metallic calcium to transparent calcium oxide. The optical scanner interpreted this reaction as loss in optical density of the slide, and this property was correlated to water vapor transmission rate (WVTR). The WVTR of some samples was also measured using a MOCON PERMATRAN-W® 700 WVTR testing system (commercially available from MOCON Inc., Minneapolis, Minn.). Four inch diameter samples were cut from sheets of coated film and loaded into the instrument, which was set to challenge one side of the film with 100% RH at 50° C. until a steady state measurement of WVTR was attained. The lowest limit of detection of this instrument is about 0.005 g/m²/day.

### Tensile Strain at Moisture Barrier Failure Testing

The tensile strain at which the moisture barrier fails is a predictor of durability in flex, with larger strain indicating greater durability. Tensile strain at moisture barrier failure is evaluated by bonding the barrier article to a 2 mil PET substrate and cutting this composite into strips 1-in. wide and 8.5-in. long. The strips are gripped in a universal test machine with a grip separation of 4-in. The grips are pulled apart at a rate of 50 mm/min until a preselected strain is reached, where strain (expressed as a percent) is defined as ε=(extension in inches/4-in.)×100. When the preselected strain is reached, the specimen is removed from the grips and the moisture barrier is evaluated as described above. The strain at which barrier failure occurs is defined as the tensile strain at which a loss of optical density of at least about 50% occurred by 75 hours of controlled environmental exposure.

In another test, the specimen is repeatedly cycled between a preselected strain and 0% strain. At 100,000 cycles, the specimen is removed from the grips and the moisture barrier is evaluated as previously described. Failure is defined as the strain at which a loss of optical density of at least about 50% occurred by 75 hours of controlled environmental exposure.

### Dynamic Fold Testing

Layer 3 (as described below) of the barrier composite was laminated to a 1 mil thick sheet of polyethylene terephthalate film using a 1 mil thick optically clear adhesive (3M™ Optically Clear Adhesive 8146-1). The release liner was then removed from the transfer layer of the barrier composite, and a 2 mil sheet of polyethylene terephthalate film was laminated to the exposed transfer layer using another piece of the 1 mil thick optically clear adhesive. This barrier laminate was cut to a 4″ length×4″ width to provide a sample suitable for testing. The sample was mounted with the 1 mil PET side down in a dynamic folding device having one stationary table and one folding table. The folding table rotated from 180 degrees (i.e. sample not bent) to 0 degrees (i.e. sample folded) with a bending radius of 1.6 mm, as determined by the gap in the folded state (0 degrees) between the two adjacent rigid plates of the folding tables. The test rate was about 30 cycles/minute and the test duration was 1,000 cycles. Dynamic fold testing was done at room temperature. Failure (such as delamination, buckling, etc.) in this test was observed and recorded, and the moisture barrier performance of the samples after folding was measured using a MOCON PERMATRAN-W® 700 system. The performance of barrier laminate samples in the dynamic fold testing depends strongly on the type and thickness of the adherends.

### Optical Retardance Test:

An M2000 ellipsometer (J.A. Woollam) was used to measure the samples. Samples were laminated with barrier adhesive to a glass slide. The samples were applied to the aperture, in the horizontal position, using double sided Scotch® Tape (3M Company). The retardance of the transmitted light was calculated using the WVase32 and RetMeas software. Retardance was measured three times at a series of sample tilt, varying from −50°→+50°, in 10° steps. The retardances were measured over the wavelength range=400-1000 nm, and the values at wavelengths 441.7 nm, 533.6 nm and 631.8 nm were further analyzed.

### Methods of Making Surface Modified Nanoparticles

All parts, percentages, ratios, etc. in the examples are by weight, unless noted otherwise.

### Preparation of Surface Modified 75 nm Silica Particles.

1-Methoxy-2-propanol (225.76 g), 3-(methacryloyloxy)propyltrimethoxysilane (3.18 g) and radical inhibitor solution (0.11 g of a 5% solution in DI water) were mixed with a dispersion of spherical silica nano-particles (200.05 g) with a silica content of 40.49% obtained under the trade designation Nalco 2329 (Nalco Company, Bedford Park, Ill.) while stirring. The solution was heated to 80° C. and held at temperature for 16 hours in a glass jar. The surface modified colloidal dispersion was further processed to remove water and increase the silica concentration.

### Preparation of Surface Modified 100 nm Silica Particles.

1-Methoxy-2-propanol (500.21 g), 3-(methacryloyloxy)propyltrimethoxysilane (6.33 g) and radical inhibitor solution (0.22 g of a 5% solution in DI water) were mixed with a dispersion of double ion-exchanged spherical silica nanoparticles (450.03 g) with a silica content of 37.65% (obtained under the trade designation Nissan MP1040 from Nissan Chemical America Corporation, Houston, Tex.) while stirring. (Pre-processing by double ion exchange is described below.) The solution was heated to 90° C. in an oil bath and held at temperature for 16 hours in a 3-neck round bottom flask. The surface colloidal dispersion was further processed to remove water and increase the silica concentration.

### Solvent Exchange of Surface Modified 75 nm Nanoparticles.

The surface modified 75 nm silica nanoparticles described above were further processed in the following manner: A one liter round bottom flask was charged with the surface modified dispersion (425.30 g). Water and 1-methoxy-2-propanol were removed via rotary evaporation to give a final weight of 272.63 g. An additional amount of 1-methoxy-2-propanol (182.54 g) was charged to the flask and water and 1-methoxy-2-propanol were again removed via rotary evaporation to give a final weight of 173.99 g. The solution was filtered with 1 micron filter. The resulting solids content was 47.22 wt. %.

### Solvent Exchange of Surface Modified 100 nm Nanoparticles.

The surface modified 100 nm silica nanoparticles described above were further processed in the following manner: A one liter round bottom flask was charged with a portion of the surface modified dispersion (454.92 g). Water and 1-methoxy-2-propanol were removed via rotary evaporation to give a final weight of 272 g. An additional amount of 1-methoxy-2-propanol (228 g) was charged to the flask and water and 1-methoxy-2-propanol were again removed via rotary evaporation to give a final weight of 186.18 g. The solution was filtered with 1 micron filter and collected in a plastic Nalgene bottle. The one liter round bottom flask was charged with the remaining surface modified dispersion (496 g). Water and 1-methoxy-2-propanol were removed via rotary evaporation to give a final weight of 223 g. An additional amount of 1-methoxy-2-propanol (228 g) was charged to the flask and water and 1-methoxy-2-propanol were again removed via rotary evaporation to give a final weight of 183.41 g. 1-methoxy-2-propanol (5.7 g) was added to the rotary evaporated solution. The solution was filtered with 1 micron filter and combined with the first batch. The resulting solids content was 46.68 wt. %.

### Method for Pre-Processing Nano-Particles by Double Ion Exchange.

The 100 nm non-functionalized nanoparticles were pre-processed prior to surface modification as follows: Dowex Monosphere 550A ion exchange resin (50.08 g) was mixed with the as-received sol of non-functionalized silica nanoparticles (1000.8 g, pH=9.09) and allowed to stir for 15 minutes. The sol reached a pH=10.95. The ion exchange resin was separated from the treated nanoparticle sol to prepare for the second ion exchange step. Amberlite IR120(H) ion exchange resin was mixed into the anion exchanged silica nanoparticle sol and allowed to stir for 20 minutes. The sol reached a pH=2.65. The Amberlite ion exchange resin was separated from the treated silica nanoparticle sol. Ammonium hydroxide (3 g) and water (17 g) were mixed together in a beaker. The double ion exchanged silica nanoparticle sol was mixed with approximately 75% of the base solution to stabilize it, giving a final pH=9.24. The resulting solids content of the double ion exchanged sol was 37.65%. A 450 g aliquot of this sol was used for surface modification of 100 nm particles as described above.

### Example 1: Construction of a Barrier Composite

A prepolymer blend was made by combining 1,6-hexanediol diacrylate and propoxylated (3) trimethylolpropane triacrylate (“SR238” and “SR492”, respectively) in a 65:35 weight ratio. The surface modified 75 nm silica particle solution (622.9 grams @ 45.3 wt. % solids), the prepolymer blend (230.89 grams), 1-methoxy-2-propanol (2583.02 grams), Irgacure 184 (15.44 grams), and Tegorad 2250 (1.04 grams) were mixed together to form a transfer layer coating solution having a 55:45 particle:prepolymer weight ratio (about 15 wt. % total solids and 3 wt. % PI, based on total solids).

The transfer layer coating solution was then coated and processed in a manner similar to the process described in WO 2013/116103 (Kolb et al.) and WO 2013/116302 (Kolb et al.). The coating solution was delivered at a rate of 20 grams/min to a 10 inch (25.4 cm) wide slot-type coating die. After the solution was coated on a 2 mil non-silicone non-fluorinated (NSNF) release liner, it then passed through a three zone air flotation oven where each zone was approximately 6.5 ft (2 m) long and was set at 130° F. (54° C.). The liner moved at a speed of 30 ft/min (15.24 cm/sec) to achieve a wet coating thickness of about 5-6 microns. Finally, the dried coating entered a gas purged UV light curing chamber, with an oxygen concentration of 5500 ppm, equipped with a UV light source (Model VSP/I600 from Fusion UV Systems Inc., Gaithersburg Md.) using an H bulb. This dried, cured coating was used as a transfer layer in the following process.

The barrier composite was prepared by coating the particulate side of the transfer layer described above with a stack comprising a base polymer layer (Layer 1), an inorganic silicon aluminum oxide (SiAlOx) barrier layer (Layer 2), and a protective polymeric layer (Layer 3) in a vacuum coater similar to the coater described in U.S. Pat. No. 5,440,446 (Shaw, et al.) and U.S. Pat. No. 7,018,713 (Padiyath et al.). The individual layers were formed as follows:

Layer 1 (base polymer layer): The transfer layer coated NSNF release liner described above was loaded into a roll-to-roll vacuum processing chamber. The chamber was pumped down to a pressure of 2.9×10⁻⁵ Torr. A web speed of 16 ft/min (8.13 cm/sec) was held while maintaining the backside (the uncoated side of the NSNF release liner) in contact with a coating drum as the film front side surface (the transfer layer) was treated with a nitrogen plasma at 0.02 kW of plasma power. The film front side surface was then coated with tricyclodecane dimethanol diacrylate monomer (obtained under the trade designation “SR833s”, from Sartomer USA, Exton, Pa.). The monomer was degassed under vacuum to a pressure of 20 mTorr prior to coating, combined with Irgacure 184 at a 95:5 ratio of SR833s:Irgacure 184, loaded into a syringe pump, and pumped at a flow rate of 1.33 mL/min through an ultrasonic atomizer operating at a frequency of 60 kHz into a heated vaporization chamber maintained at 500° F. (260° C.). The resulting monomer vapor stream condensed onto the film surface and was crosslinked by exposure to ultra-violet radiation from mercury amalgam UV bulbs (Model MNIQ 150/54 XL, Heraeus, Newark N.J.) to form an approximately 750 nm thick base polymer layer.

Layer 2 (inorganic layer): Immediately after the base polymer layer deposition and crosslinking, and with the backside of the film still in contact with the drum, a SiAlOx layer was sputter-deposited atop the base polymer layer. An alternating current (AC) 60 kW power supply (obtained from Advanced Energy Industries, Inc., of Fort Collins, Colo.) was used to control a pair of rotatable cathodes housing two 90% Si/10% Al sputtering targets (obtained from Soleras Advanced Coatings US, of Biddeford, Me.). During sputter deposition, the oxygen flow rate signal from the gas mass flow controller was used as an input for a proportional-integral-differential control loop to maintain a predetermined power to the cathode. The sputtering conditions were: AC power 16 kW, 600 V, with a gas mixture containing 350 standard cubic centimeter per minute (sccm) argon and 190 sccm oxygen at a sputter pressure of 4.0 mTorr. This resulted in an 18-28 nm thick SiAlOx layer deposited atop the base polymer layer (Layer 1).

Layer 3 (protective polymeric layer): Immediately after the SiAlOx layer deposition and with the film still in contact with the drum, a second acrylate was coated and crosslinked using the same general conditions as for Layer 1, but with this exception: The protective polymeric layer contained 3 wt. % of N-(n-butyl)-3-aminopropyltrimethoxysilane (obtained as DYNASYLAN 1189 from Evonik of Essen, Del.) and 3 wt. % Irgacure 184 with the remainder being Sartomer SR833s Optical retardance was measured according to the procedure described above and the data is shown in FIG. 5.

### Example 2. Barrier Composite Further Comprising a Matrix

A thiol-ene (TE) matrix solution was prepared by mixing 32.3 grams of TEMPIC, 15.8 grams of TAIC and 0.4 gram of TPO-L. The solution was knife coated with a coating thickness of approximately 100 μm on Layer 3 of the barrier composite provided in Example 1 and then laminated to a 2 mil PET film. The construction was exposed to 1 J/cm² of actinic radiation of duration approximately 1 second (Heraeus Noblelight Fusion UV D-Bulb). The NSNF release liner on top of the barrier composite was then removed. Optical transmission, haze, clarity and water vapor transmission rate were measured for Example 2 according to the procedure described, for example, in U.S. Pat. No. 8,922,733 (Wheatley et al.). The results are shown in Table 2. Optical retardance was measured according to the procedure described above and the data is shown in FIG. 5.

### Example 3

A prepolymer blend was made by combining 1,6-hexanediol diacrylate and propoxylated (3) trimethylolpropane triacrylate (“SR238” and “SR492”, respectively) in a 65:35 weight ratio. The modified particle solution (1100.03 grams @ 46.61 wt. % solids), the above prepolymer blend (314.79 grams), 1-methoxy-2-propanol (1406.62 grams), Irgacure 184 (8.55 grams), and Tegorad 2250 (1.7 grams) were mixed together to form the transfer layer coating solution having a 55:45 particle:prepolymer weight ratio (about 15 wt. % total solids and 3 wt. % PI, based on total solids).

The transfer layer coating solution described above was delivered at a rate of 42 grams/min to a 10 inch (25.4 cm) wide slot-type coating die. After the solution was coated on a 2 mil NSNF release liner, it then passed through a three zone air flotation oven where each zone was approximately 6.5 ft (2 m) long and was set at 130° F. (54° C.). The substrate moved at a speed of 30 ft/min (15.24 cm/sec) to achieve a wet coating thickness of about 11-12 microns. Finally the dried coating entered a gas purged UV chamber, with an oxygen concentration of 1960 ppm, equipped with a UV light source (Model VSP/I600 from Fusion UV Systems Inc.) using an H bulb. This dried, cured coating was used as a transfer layer in the following process.

A barrier composite was prepared by coating the particulate side of the transfer layer described above with a stack of a base polymer layer (Layer 1), an inorganic silicon aluminum oxide (SiAlOx) barrier layer (Layer 2), and a protective polymeric layer (Layer 3) in a vacuum coater. The individual layers were formed as follows:

Layer 1 (base polymer layer): The above described film was loaded into a roll-to-roll vacuum processing chamber. The chamber was pumped down to a pressure of 2×10⁻⁵ Torr. A web speed of 16 ft/min (8.13 cm/sec) was held while maintaining the backside (the uncoated side of the NSNF release liner) of the film in contact with a coating drum as the film front side surface (the transfer layer) was treated with a nitrogen plasma at 0.02 kW of plasma power. The film front side surface was then coated with tricyclodecane dimethanol diacrylate monomer (obtained under the trade designation “SR833s”, from Sartomer USA, Exton, Pa.). The monomer was degassed under vacuum to a pressure of 20 mTorr prior to coating, loaded into a syringe pump, and pumped at a flow rate of 1.33 mL/min through an ultrasonic atomizer operating at a frequency of 60 kHz into a heated vaporization chamber maintained at 500 F (260 C). The resulting monomer vapor stream condensed onto the film surface and was electron beam crosslinked using a multi-filament electron beam cure gun operating at 7.0 kV and 4 mA to form an approximately 750 nm thick base polymer layer.

Layer 2 (inorganic layer): Immediately after the base polymer layer deposition and crosslinking, and with the backside of the film still in contact with the drum, a SiAlOx layer was sputter-deposited atop the base polymer layer. An alternating current (AC) 60 kW power supply (obtained from Advanced Energy Industries, Inc., Fort Collins, Colo.) was used to control a pair of rotatable cathodes housing two 90% Si/10% Al sputtering targets (obtained from Soleras Advanced Coatings US, of Biddeford, Me.). During sputter deposition, the oxygen flow rate signal from the gas mass flow controller was used as an input for a proportional-integral-differential control loop to maintain a predetermined power to the cathode. The sputtering conditions were: AC power 16 kW, 600 V, with a gas mixture containing 350 standard cubic centimeter per minute (sccm) argon and 195 sccm oxygen at a sputter pressure of 4.4 mTorr. This resulted in an 18-28 nm thick SiAlOx layer deposited atop the base polymer layer.

Layer 3 (protective polymeric layer): Immediately after the SiAlOx layer deposition and with the film still in contact with the drum, a second acrylate was coated and crosslinked using the same general conditions as for Layer 1, but with these exceptions: (1) Electron beam crosslinking was carried out using a multi-filament electron beam cure gun operated at 7.0 kV and 10 mA. (2) The protective polymeric layer contained 3 wt. % of N-(n-butyl)-3-aminopropyltrimethoxysilane (obtained as DYNASYLAN 1189 from Evonik of Essen, Del.) with the remainder Sartomer SR833s.

A sample of the barrier composite just described was cut and laminated to a layer of flexible transparent barrier adhesive described in U.S. Pat. No. 8,232,350 (Fujita et al.). This laminated construction was used to encapsulate a calcium metal pad that had been previously deposited onto a glass slide, also as described in U.S. Pat. No. 8,232,350, with all steps of calcium encapsulation carried out in a nitrogen inert glove box. Once the laminated construction was secured over the calcium, the NSNF release liner PET film was peeled away leaving behind just the substrate-less barrier material/barrier adhesive laminate encapsulating the calcium pad. A second calcium pad was also encapsulated with the barrier composite with the NSNF release liner left in place.

A high resolution flatbed scanner was used to generate initial images of the encapsulated calcium pads. The samples were then placed into a 60° C./90% RH environmental chamber where they were aged for 215 hours and then scanned again. Initial and 215 hour images of the encapsulated pads were compared to a control sample consisting of a calcium pad encapsulated with 3M product FTB3-50 (flexible transparent barrier with 10⁻³ g/m² day WVTR performance 50 microns thick) barrier film and the same adhesive. The images revealed little to no difference when compared to the control after 215 hours of aging. This suggests that the barrier performance of the invention was at least as good as that of the current product which was estimated to be in the 10⁻⁵ to 10⁻³ g/m² day range at room temperature.

The optical density loss data are reported in Table 1 for the initial and 215 hour images of the control (FTB3-50), and the samples from this example with the liner in place, and without the liner. Lower optical density loss meant better resistance to water vapor transmission.

TABLE 1
Optical density loss data

| Time at | | Example | Example |
|---|---|---|---|
| 60 C./90% RH | FTB3-50 | 3 (liner in | 3 (liner |
| (hours) | (Control) | place) | removed) |
| 0 | 0% | 0% | 0% |
| 215 | 26.37% | 34.84% | 32.82% |

### Example 4: Preparation of a Substrate-Less Quantum Dot Enhancement Film (QDEF)

A thiol-ene (TE) matrix was prepared by mixing 32.3 grams of TEMPIC, 15.8 grams of TAIC and 0.4 gram of TPO-L. In a dry, nitrogen-only environment, 0.41 grams of red quantum dot concentrate and 1.59 grams of green quantum dot concentrate was added to this matrix and mixed with a cowles blade for 5 minutes. The solution was knife coated on the Layer 3 side of one of the two barrier composites made as in Example 3 above, with a coating thickness of approximately 100 μm. The two barrier composites were then laminated with the Layer 3 sides facing one another. The construction was exposed to 200mJ/cm² of actinic radiation of duration 30 seconds (using a CF200 UV-LED from Clearstone Technologies, Hopkins Minn., operating at 385 nm, 100-240V, 6.0-3.5 A, and 50-60 Hz). The NSNF release liners were then removed from each side of the construction, resulting in a 110 μm thick substrate-less quantum dot enhancement film (QDEF).

### Comparative Example

### Preparation of a 210 μm Thick QDEF Film.

Using the TE matrix from Example 4, the matrix was knife coated on one of two FTB3-M-50 barrier films with a coating thickness of approximately 100 μm. The two barrier films were then laminated with the TE matrix solution between them. The construction was exposed to 200mJ/cm² of actinic radiation of duration 30 seconds (using a CF200 UV-LED from Clearstone Technologies, Hopkins Minn. operating at 385 nm, 100-240V 6.0-3.5 A, and 50-60 Hz).

### Optical Properties of Example 4 and Comparative Example.

Samples from the construction from Example 4 and Comparative Example were then tested. Measurements included luminance, color (white point CIE1931 coordinates), peak wavelength for both green and red quantum dots (PWL-G and PWL-R), and axial efficiency. Axial efficiency was determined as the relative output of red and green emitted by the sample with respect to the amount of absorbed blue light as measured on an axis normal to the sample. Color and luminance were measured using a blue (450 nm) diffuse light source measuring 40 nits and cross-BEF (from 3M Company). A PR-650 spectrophotometer (from Photo Research, Chatsworth Calif.) was used to collect the radiance spectra. Two sheets of BEF4-GT-90 (from 3M Company) were placed on top of the sample, which was on top of a diffuse light source. The measurement procedure was further described in U.S. provisional patent application 62/232,071 (Eckert et al.), now PCT Application No. US2016/053339, filed 23 Sep. 2016.

The samples were tested initially, as made, and then after accelerated aging. One set of samples were aged at 85° C. and tested after 100 and 500 hours. Another set was aged at 65° C. and 95% relative humidity and tested after 100 and 500 hours. Measurements are reported in Table 3.

### Example 5

Two barrier film stacks were prepared. For the first, a prepolymer blend was made by combining 1,6-hexanediol diacrylate and propoxylated (3) trimethylolpropane triacrylate (“SR238” and “SR492”, respectively) in a 65:35 weight ratio. The surface modified 75 nm particle solution (1320.02 grams @ 45.3 wt. % solids), the above prepolymer blend (489.27 grams), 1-methoxy-2-propanol (1814.76 grams), Irgacure 184 (32.73 grams), and Tegorad 2250 (2.19 grams) were mixed together to form the transfer layer coating solution (about 30 wt. % total solids and 3 wt. % PI, based on total solids, and having a 55:45 particle:prepolymer weight ratio).

The transfer layer coating solution described above was delivered at a rate of 42 grams/min to a 10 inch (25.4 cm) wide slot-type coating die. After the solution was coated on a 2 mil thick NSNF release liner, it then passed through a three zone air flotation oven where each zone was approximately 6.5 ft (2 m) long and was set at 130° F. (54° C.). The substrate moved at a speed of 30 ft/min (15.24 cm/sec) to achieve a wet coating thickness of about 11-12 microns. Finally the dried coating entered a gas purged UV chamber, with an oxygen concentration of 5500 ppm, equipped with a UV light source (Model VSP/I600 from Fusion UV Systems Inc.) using an H bulb. This dried, cured coating was used as a transfer layer in the following process.

The barrier film stack was then assembled from three layers. To form Layer 1, the above described film was loaded into a roll-to-roll vacuum processing chamber. The chamber was pumped down to a pressure of 2×10⁻⁵ Torr. A web speed of 16 ft/min (8.13 cm/sec) was held while maintaining the backside of the film (the uncoated side of the NSNF release liner) in contact with a coating drum as the film front side surface (the transfer layer side) was treated with a nitrogen plasma at 0.02 kW of plasma power. The film front side surface was then coated with tricyclodecane dimethanol diacrylate monomer (obtained under the trade designation “SR833s”, from Sartomer USA, Exton, Pa.). The monomer was degassed under vacuum to a pressure of 20 mTorr prior to coating, combined with Irgacure 184 at a 95:5 ratio of SR833s:Irgacure 184, loaded into a syringe pump, and pumped at a flow rate of 1.33 mL/min through an ultrasonic atomizer operating at a frequency of 60 kHz into a heated vaporization chamber maintained at 500 F (260 C). The resulting monomer vapor stream condensed onto the film surface and was crosslinked by exposure to ultra-violet radiation from mercury amalgam UV bulbs (Model MNIQ 150/54 XL, Heraeus) to form an approximately 750 nm thick base polymer layer.

Immediately after the base polymer layer deposition and crosslinking, and with the backside of the film still in contact with the drum, Layer 2 was formed as a SiAlOx layer, sputter-deposited atop the base polymer layer. An alternating current (AC) 60 kW power supply (obtained from Advanced Energy Industries, Inc., of Fort Collins, Colo.) was used to control a pair of rotatable cathodes housing two 90% Si/10% Al sputtering targets (obtained from Soleras Advanced Coatings US, Biddeford, Me.). During sputter deposition, the oxygen flow rate signal from the gas mass flow controller was used as an input for a proportional-integral-differential control loop to maintain a predetermined power to the cathode. The sputtering conditions were: AC power 16 kW, 600 V, with a gas mixture containing 350 standard cubic centimeter per minute (sccm) argon and 212 sccm oxygen at a sputter pressure of 3.8 mTorr. This resulted in an 18-28 nm thick SiAlOx layer deposited atop Layer 1.

Immediately after the SiAlOx layer deposition and with the film still in contact with the drum, layer 3 was formed as a second acrylate was coated and crosslinked using the same general conditions as for layer 1, but with this exception: The protective polymeric layer contained 3 wt. % of N-(n-butyl)-3-aminopropyltrimethoxysilane (obtained as DYNASYLAN 1189 from Evonik, Essen, Del.) and 3 wt. % Irgacure 184 with the remainder being Sartomer SR833s.

A second separate barrier composite was then formed. A prepolymer blend was made by combining 1,6-hexanediol diacrylate and propoxylated (3) trimethylolpropane triacrylate (“SR238” and “SR492”, respectively) in a 65:35 weight ratio. The surface modified 75 nm particle solution (1320.02 grams @ 45.3 wt. % solids), the above prepolymer blend (489.27 grams), 1-methoxy-2-propanol (1814.76 grams), Irgacure 184 (32.73 grams), and Tegorad 2250 (2.19 grams) were mixed together to form the coating solution (about 30 wt. % total solids and 3 wt. % PI, based on total solids, and having a 55:45 particle:prepolymer weight ratio.).

The coating solution described above was delivered at a rate of 42 grams/min to a 10 inch (25.4 cm) wide slot-type coating die. After the solution was coated on a 2 mil thick NSNF release liner, it then passed through a three zone air flotation oven where each zone was approximately 6.5 ft (2 m) long and was set at 130° F. (54° C.). The substrate moved at a speed of 30 ft/min (15.24 cm/sec) to achieve a wet coating thickness of about 11-12 microns. Finally the dried coating entered a gas purged UV chamber, with an oxygen concentration of 5500 ppm, equipped with a UV light source (Model VSP/I600 from Fusion UV Systems Inc.) using an H bulb. This dried, cured coating was used as a transfer layer in the following process.

A barrier composite was then formed as before. To form Layer 1, the above described film was loaded into a roll-to-roll vacuum processing chamber. The chamber was pumped down to a pressure of 2.9×10⁻⁵ Torr. A web speed of 16 ft/min (8.13 cm/sec) was held while maintaining the backside of the film (the uncoated side of the NSNF release liner) in contact with a coating drum as the film front side surface (the transfer layer) was treated with a nitrogen plasma at 0.02 kW of plasma power. The film front side surface was then coated with tricyclodecane dimethanol diacrylate monomer (obtained under the trade designation “SR833s”, from Sartomer USA, Exton, Pa.). The monomer was degassed under vacuum to a pressure of 20 mTorr prior to coating, combined with Irgacure 184 at a 95:5 ratio of SR833s:Irgacure 184, loaded into a syringe pump, and pumped at a flow rate of 1.33 mL/min through an ultrasonic atomizer operating at a frequency of 60 kHz into a heated vaporization chamber maintained at 500 F (260 C). The resulting monomer vapor stream condensed onto the film surface and was crosslinked by exposure to ultra-violet radiation from mercury amalgam UV bulbs (Model MNIQ 150/54 XL, Heraeus) to form an approximately 750 nm thick base polymer layer.

Immediately after the base polymer layer deposition and crosslinking, and with the backside of the film still in contact with the drum, Layer 2 was formed as a SiAlOx layer, sputter-deposited atop the base polymer layer. An alternating current (AC) 60 kW power supply (obtained from Advanced Energy Industries, Inc., of Fort Collins, Colo.) was used to control a pair of rotatable cathodes housing two 90% Si/10% Al sputtering targets (obtained from Soleras Advanced Coatings US, Biddeford, Me.). During sputter deposition, the oxygen flow rate signal from the gas mass flow controller was used as an input for a proportional-integral-differential control loop to maintain a predetermined power to the cathode. The sputtering conditions were: AC power 16 kW, 600 V, with a gas mixture containing 350 standard cubic centimeter per minute (sccm) argon and 190 sccm oxygen at a sputter pressure of 4.0 mTorr. This resulted in an 18-28 nm thick SiAlOx layer deposited atop Layer 1.

Immediately after the SiAlOx layer deposition and with the film still in contact with the drum, Layer 3 was formed as a second acrylate was coated and crosslinked using the same general conditions as for Layer 1, but with this exception: The protective polymeric layer contained 3 wt. % of N-(n-butyl)-3-aminopropyltrimethoxysilane (obtained as DYNASYLAN 1189 from Evonik, Essen, Del.) and 3 wt. % Irgacure 184 with the remainder being Sartomer SR833s.

A thiol-ene matrix solution was prepared as in Example 2 and knife coated with a thickness of 50 microns on the Layer 3 side of one of the two barrier composites just described. The two barrier composites were then laminated with the NSNF release liners on the exterior surfaces and the thiol-ene matrix between them. The construction was exposed to 1 J/cm² of actinic radiation of duration approximately 1 second (Heraeus Noblelight Fusion UV D-Bulb). The NSNF release liner was removed from both sides.

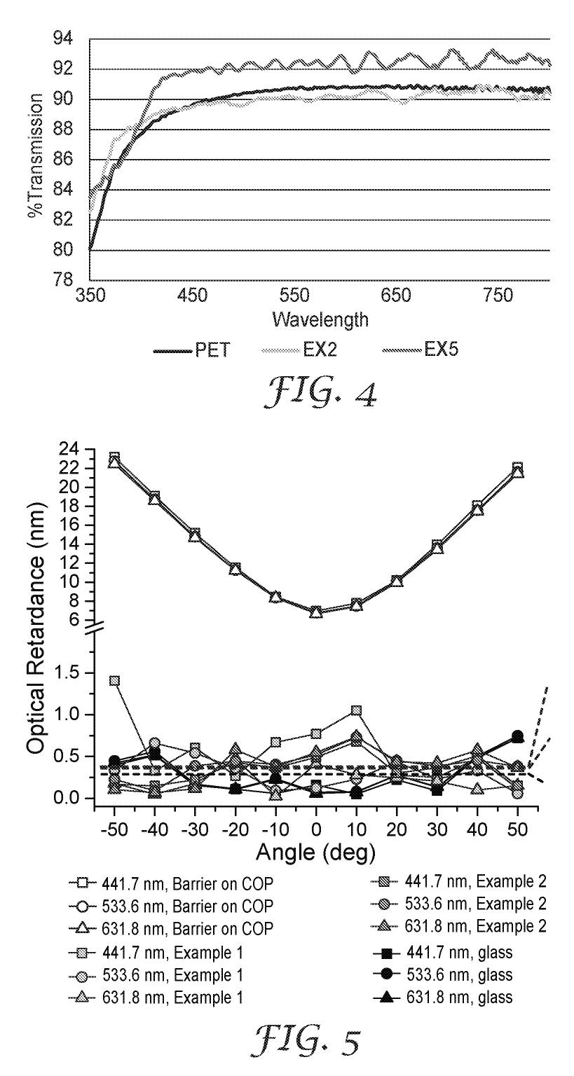

Optical and moisture barrier performance for this construction were then evaluated. Transmission, haze and clarity were measured as in Example 2 using a BYK HazeGard (available from BYK-Gardner, Columbia Md.). Average transmission from 390 to 700 nm was also determined. Moisture performance was measured as previously described using a Permatran 700. Results are presented in Table 2. For comparison, similar tests were done with the construction of Example 2 as well as ordinary PET. Optical transmission from 350 to 800 nm wavelengths for PET and the constructions of Examples 2 and 5 are shown in FIG. 4.

TABLE 2

| | | | | | | WVTR |
|---|---|---|---|---|---|---|
| | | | | | | (g/m²- |
| | Thick- | Average | Trans- | | | day, 50 C.) |
| | ness | % T | mission | Haze | Clarity | Permatran |
| | um | 390-700 nm | BYK Haze Guard | | | 700 |
| PET | 50 | 90.21 | 93.5 | 8.96 | 91.1 | 25 |
| Exam- | 3 | 89.86 | 92.6 | 2.81 | 95.7 | 0.01 |
| ple 2 | | | | | | |
| Exam- | 60 | 91.95 | 94.7 | 8.91 | 91.1 | <0.005 |
| ple 5 | | | | | | |

TABLE 3

| | | | | | | |
|---|---|---|---|---|---|---|
| | | | | | | Axial |
| | Lumi- | | | PWL-G | PWL-R | Efficiency |
| Sample | nance | X | y | (nm) | (nm) | (%) |

Initial Data

| | | | | | | |
|---|---|---|---|---|---|---|
| Comparative | 318 | 0.2179 | 0.1869 | 532 | 626 | 61.7 |
| Example 4 | 358 | 0.2382 | 0.2178 | 533 | 626 | 66.4 |

t = 100 hours 85 C.

| | | | | | | |
|---|---|---|---|---|---|---|
| Comparative | 319 | 0.2190 | 0.1881 | 532 | 626 | 61.8 |
| Example 4 | 362 | 0.2403 | 0.2201 | 533 | 626 | 67.1 |

t = 500 hours 85 C.

| | | | | | | |
|---|---|---|---|---|---|---|
| Comparative | 316 | 0.2202 | 0.1865 | 532 | 626 | 61.0 |
| Example 4 | 344 | 0.2394 | 0.2131 | 533 | 626 | 63.6 |

t = 100 hours 65/95

| | | | | | | |
|---|---|---|---|---|---|---|
| Comparative | 326 | 0.2195 | 0.1904 | 532 | 626 | 63.3 |
| Example 4 | 365 | 0.2404 | 0.2220 | 533 | 626 | 67.4 |

t = 500 hours 65/95

| | | | | | | |
|---|---|---|---|---|---|---|
| Comparative | 324 | 0.2207 | 0.1912 | 532 | 626 | 62.1 |
| Example 4 | 362 | 0.2409 | 0.2205 | 533 | 626 | 66.5 |

### Example 6

A double barrier composite was constructed as in Example 5, but one of the NSNF release liners was left in place. A barrier adhesive (as described in Example 3) with a release liner was laminated to the exposed stack (the side that was just exposed by removing one of the NSNF release liners—opposite the side of the stack with a NSNF release liner still in place). This construction can be used to encapsulate a moisture sensitive device such as an OLED.

### Example 7: Fabrication of a Single Layer Barrier Composite

A prepolymer blend was made by combining propoxylated (2) neopentylglycol diacrylate and a proprietary aliphatic urethane acrylate oligomer supplied by Sartomer (trade designations SR9003B and CN991, respectively) in an 80:20 weight ratio. The surface modified 75 nm silica particle dispersion described above (610.00 grams @ 47.2 wt % solids), the prepolymer blend (672.29 grams), 1-methoxy-2-propanol (575.22 grams), isopropyl alcohol (1342.02 grams), Irgacure 184 (photoinitiator, 19.40 grams), and Tegorad 2250 (0.98 grams) were mixed together to form a coating solution (about 30 wt % total solids and 2 wt % photoinitiator, based on total solids). The coating solution contained surface modified 75 nm silica particles and prepolymer blend in a 30:70 weight ratio. The coating solution was then coated and processed in a manner similar to the process described in WO 2013/116103 (Kolb et al.) and WO 2013/116302 (Kolb et al.). The coating solution was delivered at a rate of 36 grams/min to a 10 inch (25.4 cm) wide slot-type coating die. After the solution was coated on a 2 mil thick non-silicone non-fluorinated (NSNF) release liner, the coated release liner passed through a three zone air flotation oven where each zone was approximately 6.5 ft (2 m) long and set at 150° F. (65.5° C.), 190° F. (87.8° C.), and 220° F. (104.4° C.), respectively. The release liner moved at a speed of 30 ft/min (15.24 cm/sec) to achieve a wet coating thickness of about 9-10 microns. Finally, the dried coating entered a nitrogen-purged UV light curing chamber that had an oxygen concentration less than 100 ppm and was equipped with a UV light source (Model VSP/I600 from Fusion UV Systems Inc., Gaithersburg Md.) using an H bulb. This dried, cured coating was used as a transfer layer in the following process. A flexible barrier composite was prepared by sequentially coating the transfer layer of the construction described above with a base polymer layer (Layer 1), an inorganic silicon aluminum oxide (SiAlOx) barrier layer (Layer 2), and a protective polymeric layer (Layer 3) in a vacuum coater similar to the coater described in U.S. Pat. No. 5,440,446 (Shaw, et al.) and U.S. Pat. No. 7,018,713 (Padiyath et al.). The individual layers were formed as follows: Layer 1 (base polymer layer): The transfer layer coated NSNF release liner described above was loaded into a roll-to-roll vacuum processing chamber. The chamber was pumped down to a pressure of 2.2×10-5 Torr. A web speed of 16 ft/min (8.13 cm/sec) was held while maintaining the backside (the uncoated side of the NSNF release liner) in contact with a coating drum as the front side surface (the transfer layer) was treated with a nitrogen plasma at 0.02 kW of plasma power. The front side surface was then coated with tricyclodecane dimethanol diacrylate monomer (obtained under the trade designation “SR833s”, from Sartomer USA, Exton, Pa.). Prior to coating, the SR833s monomer was degassed under vacuum to a pressure of 20 mTorr and combined with Irgacure 184 at a 99:1 weight ratio of SR833s:Irgacure 184. This monomer mixture was then loaded into a syringe pump, and pumped at a flow rate of 0.83 mL/min through an ultrasonic atomizer operating at a frequency of 60 kHz into a heated vaporization chamber maintained at 500° F. (260° C.). The resulting monomer vapor stream condensed onto the transfer layer surface and was crosslinked by exposure to ultra-violet radiation from mercury amalgam UV bulbs (Model MNIQ 150/54 XL, Heraeus, Newark N.J.) to form an approximately 470 nm thick base polymer layer. Layer 2 (inorganic layer): Immediately after the base polymer layer deposition and crosslinking, and with the release liner backside still in contact with the drum, a SiAlOx layer was sputter-deposited atop the base polymer layer. An alternating current (AC) 60 kW power supply (obtained from Advanced Energy Industries, Inc., Fort Collins, Colo.) was used to control a pair of rotatable cathodes housing two 90% Si/10% Al sputtering targets (obtained from Soleras Advanced Coatings US, Biddeford, Me.). During sputter deposition, the oxygen flow rate signal from the gas mass flow controller was used as an input for a proportional-integral-differential control loop to maintain a predetermined power to the cathode. The sputtering conditions were: AC power 16 kW, 600 V, with a gas mixture containing 350 standard cubic centimeter per minute (sccm) argon and 212 sccm oxygen at a sputter pressure of 2.4 mTorr. This resulted in an 18-28 nm thick SiAlOx layer deposited atop the base polymer layer (Layer 1). Layer 3 (protective polymeric layer): Immediately after the SiAlOx layer deposition and with the release liner still in contact with the drum, a second acrylate was coated and crosslinked using the same general conditions as for Layer 1, but with these exceptions: The protective polymeric layer contained 3 wt % of N-(n-butyl)-3-aminopropyltrimethoxysilane (obtained as DYNASYLAN 1189 from Evonik, Essen, Del.) and 1 wt % Irgacure 184 with the remainder being Sartomer SR833s. The monomer mixture was delivered at a flow rate of 1.77 mL/min resulting in an approximately 1000 nm thick top polymer layer.

Dynamic fold testing, as described above, was performed using this barrier composite. The moisture barrier performance of a barrier laminate made with this barrier composite and subjected to dynamic fold testing, and of a control barrier laminate sample (that had not been subjected to fold testing), were evaluated using a Mocon Permatran-W® 700 system, as described above. The data is presented in Table 4, and shows that the barrier laminate survived fold testing with no detectable increase in WVTR.

TABLE 4
WVTR test results of barrier laminate subjected to dynamic
fold testing and of a control (untested) laminate.

| Sample | Water Vapor Transmission Rate |
|---|---|
| Folded Barrier Laminate | Below Mocon Permatran-W 700 Detection |
| | Limit, <0.005 g/m²/day |
| Control Barrier Laminate | Below Mocon Permatran-W 700 Detection |
| | Limit, <0.005 g/m²/day |

### Example 8: Fabrication of a Double Layer Barrier Composite

A prepolymer blend of a proprietary trifunctional aliphatic urethane acrylate oligomer supplied by Sartomer and isobornyl acrylate (trade designations CN929 and SR506a, respectively) in a 65.5:35.5 weight ratio was mixed. The prepolymer blend (1980 grams), methyl ethyl ketone (2000 grams), and 20 grams of the photoinitiator 2,4,6-trimethylbenzoylphenylphospinic acid ethyl ester were mixed together to form a matrix layer coating solution (about 50 wt % total solids and 1 wt % photoinitiator, based on total solids). The matrix layer coating solution described above was delivered at a rate of 35 grams/min to a 10 inch (25.4 cm) wide slot-type coating die. After the solution was coated on Layer 3 of the barrier composite of Example 7, it then passed through a three zone air flotation oven where each zone was approximately 6.5 ft (2 m) long and set at 150° F. (65.5° C.), 160° F. (71.1° C.), and 170° F. (76.7° C.), respectively. The release liner moved at a speed of 30 ft/min (15.24 cm/sec) to achieve a wet coating thickness of about 10-12 microns. Once the matrix layer coating was dry, Layer 3 of a second barrier composite of Example 7 was laminated onto the dried matrix layer coating to form an uncured laminate. Finally, the uncured laminate entered a nitrogen-purged UV light curing chamber, with an oxygen concentration of less than 100 ppm, equipped with a UV light source (Model VSP/I600 from Fusion UV Systems Inc.) using an D bulb, producing a cured double layer barrier composite.

### Example 9: Barrier Laminate Further Comprising a Barrier Adhesive

Escorez 5300 hydrogenated petroleum hydrocarbon resin was purchased from ExxonMobil Chemical Company (Houston, Tex.). Polyisobutylene with formula weights of: (i) 400,000 g/mol (Oppanol B50 SF); (ii) 800,000 g/mol (Oppanol B80) were obtained from BASF (Florham Park, N.J.). Toluene were purchased from VWR International (Radnor, Pa.). Rolls of SKC-02N release liner were purchased from SKC Haas (Seoul, Korea). Aldrich 634182 calcium oxide nanopowder was purchased from Sigma-Aldrich (Saint Louis, Mo.). Hydrophobically-modified 20-nm silica was obtained using the method of U.S. Provisional Patent Application No. 62/351,086, filed 16 Jun. 2016.

A barrier laminate as described in Example 7 was laminated to a barrier adhesive of the type described in U.S. Provisional Patent Application No. 62/351,086, filed 16 Jun. 2016. A barrier adhesive solution was made using a 10 gallon Ross triple-shaft VersaMix compounder. To make the barrier adhesive solution, 0.1 lb Aldrich calcium oxide nanopowder particles (Catalog No. 634182) and 0.5 lb hydrophobically-modified 20-nm silica particles (described in U.S. Provisional Patent Application No. 62/351,086) were added to the compounder along with 40 lb toluene. The particles were dispersed using a rotor-stator mixer, high-shear mixer, and anchor blade for 1 hour. When the particles were dispersed, 4.7 lb Oppanol B80 polyisobutylene, 2.35 lb Oppanol B50 polyisobutylene, and 2.35 lb Escorez 5300 tackifier were added to the compounder. The Oppanol B80 and Oppanol B50 were diced into 1″ cubes before being added to the compounder. The solution was mixed using a rotor-stator mixer, high-shear mixer, and anchor blade until the resin (polyisobutylenes and tackifier) was homogeneous, which took 20 hours.

The barrier adhesive solution was then pumped using a 5.0 cc/rev Zenith pump through a 50 μm filter and coated onto the release side of SKC-02N release liner with a B&M Die coating head. The coated release liner was then passed through a gap dryer at 150° F., a first oven zone at 176° F., a second oven zone at 248° F., and a third oven zone at 248° F. The toluene was removed in the ovens, leaving the barrier adhesive composition having the composition shown in Table 5 on the release liner.

TABLE 5
Composition of barrier adhesive.

| Material | Composition | |
|---|---|---|
| Oppanol B80 | 47 | wt % |
| Oppanol B50 | 23.5 | wt % |
| Escorez 5300 | 23.5 | wt % |
| Hydrophobically-modified 20-nm silica | 5 | wt % |
| Aldrich 634182 calcium oxide nanopowder | 1 | wt % |

The resulting dry thickness of the barrier adhesive after passage through the ovens was 12 microns. After drying, the protective layer (Layer 3) surface of the single layer barrier composite of Example 7 was laminated to the barrier adhesive through a nip, resulting in a product comprising a barrier laminate further laminated to a barrier adhesive.

### Optical Properties and WVTR Measurements for Examples 8 and 9

Optical properties of the barrier composites of Examples 8 and 9 were measured using a BYK Haze Guard, as described above for Example 5. Example 9 was laminated to glass and the remaining NSNF release liner was removed before analysis. WVTR data was measured using a PERMATRAN W 700 as described above in Moisture Barrier Performance and is reported in Table 6.

TABLE 6
Optical properties and WVTR data for
Examples 8 and 9, compared to PET.

| | | | | | WVTR |
|---|---|---|---|---|---|
| | | Transmission | Haze | Clarity | (g/m² · day, |
| | Thickness | (%) | (%) | (%) | 50° C.) |
| | (microns) | BYK Haze Guard | | | Permatran W 700 |
| PET | 50 | 93.5 | 8.96 | 91.1 | 25 |
| Example 8 | 13 | 94 | 2.31 | 98.1 | <.005 |
| Example 9 | 16 | 92.5 | 3.15 | 98.3 | <.005 |

### Example 10: A Double Layer Barrier Composite Further Comprising a Barrier Adhesive

One layer of NSNF release liner was removed on-line from the double layer barrier composite of Example 8, exposing one of the transfer layers. The exposed transfer layer was laminated to the exposed dried barrier adhesive (described in Example 9) through a nip, resulting in a product comprising a double layer barrier laminate further laminated to a barrier adhesive.

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A barrier composite comprising:
(a) a gas-barrier film;
(b) a polymeric transfer layer disposed on the gas-barrier film; and
(c) a release liner disposed on the polymeric transfer layer opposite the gas-barrier film.

2. The barrier composite of claim 1 wherein the transfer layer comprises a polymer formed from polymerizable material comprising multifunctional (meth)acrylate.

3. The barrier composite of claim 1 wherein the transfer layer comprises sub-micrometer particles dispersed in the transfer layer.

4. The barrier composite of claim 3 wherein the sub-micrometer particles are surface-modified.

5. The barrier composite of claim 4 wherein the sub-micrometer particles are surface-modified silica sub-micrometer particles.

6. The barrier composite of claim 1 wherein the major surface of the transfer layer adjacent the gas-barrier film has nano-scale roughness.

7. The barrier composite of claim 1 wherein the transfer layer has a thickness of about 0.1 microns to about 8 microns.

8. The barrier composite of claim 7 wherein the transfer layer has a thickness of about 0.5 microns to about 6 microns.

9. The barrier composite of claim 1 wherein the release liner comprises PET film and a non-silicone non-fluorinated release material.

10. The barrier composite of claim 1 wherein release liner comprises a release material formed by irradiating a release material precursor,
wherein the release material precursor has a shear storage modulus of about 1×10² to about 3×10⁶ Pa when measured at 20° C. and at a frequency of 1 Hz, and
wherein the release material has a contact angle of 15° or more, as measured using a mixed solution of methanol and water (volume ratio 90:10) having a wet tension of 25.4 mN/m.

11. The barrier composite of claim 1 wherein the gas-barrier film is an ultra-barrier film having an oxygen transmission rate less than about 0.005 cc/m²/day at 23° C. and 90% RH and a water vapor transmission rate of less than about 0.005 g/m²/day at 23° C. and 90% RH.

12. The barrier composite of claim 11 wherein the ultra-barrier film is a multilayer film comprising an inorganic visible light-transmissive layer disposed between polymer layers.

13. The barrier composite of claim 1 wherein the gas-barrier film has a thickness of about 0.3 microns to about 10 microns.

14. The barrier composite of claim 13 wherein the gas-barrier film has a thickness of about 1 micron to about 8 microns.

15. The barrier composite of claim 1 wherein the gas-barrier film and the transfer layer are non-birefringent.

16. The barrier composite of claim 1 further comprising an adhesive layer disposed on the gas-barrier film opposite the transfer layer.

17. The barrier composite of claim 16 wherein the adhesive layer comprises a UV-cured adhesive.

18. The barrier composite of claim 16 wherein the adhesive layer comprises a barrier adhesive.

19. The barrier composite of claim 1 adhered on a substrate.

20. The barrier composite of claim 19 wherein the substrate is a polarizer, a diffuser or a touch sensor.

21. An encapsulated thin film device comprising the barrier composite of claim 1 encapsulating a thin film device.

22. The encapsulated thin film device of claim 21 wherein the encapsulated thin film device has a thickness of less than about 200 microns.

23. The encapsulated thin film device of claim 21 wherein the device is an OLED.

24. The encapsulated thin film device of claim 21 wherein the device is selected from the group consisting of a solar cell, an electrophoretic display, an electrochromic display, a thin film battery, a quantum dot device, a sensor and combinations thereof.

25. The encapsulated thin film device of claim 21 further comprising a polarizer, a diffuser, a touch sensor or a combination thereof.

26. A double barrier composite comprising:
(a) a first barrier composite comprising a first gas-barrier film disposed on a first polymeric transfer layer;
(b) a second barrier composite comprising a second gas-barrier film disposed on a second polymeric transfer layer; and
(c) a layer comprising a cross-linked polymer layer disposed between the first gas-barrier film and the second gas-barrier film.

27. The double barrier composite of claim 26 wherein the first transfer layer and the second transfer layer each have a thickness of about 0.1 microns to about 8 microns.

28. The double barrier composite of claim 27 wherein the first transfer layer and the second transfer layer each have a thickness of about 0.5 microns to about 6 microns.

29. The double barrier composite of claim 26 wherein the first gas-barrier film and the second gas-barrier film each have a thickness of about 0.3 microns to about 10 microns.

30. The double barrier composite of claim 29 wherein the first gas-barrier film and the second gas-barrier film each have a thickness of about 1 micron to about 8 microns.

31. The double barrier composite of claim 26 wherein the cross-linked polymer layer has a thickness of about 2 microns to about 200 microns.

32. The double barrier composite of claim 31 wherein the cross-linked polymer layer has a thickness of about 2 microns to about 100 microns.

33. The double barrier composite of claim 26 wherein all components of the double barrier composite are non-birefringent.

34. The double barrier composite of claim 26 wherein quantum dots are dispersed in the cross-linked polymer layer.

35. The double barrier composite of claim 26 wherein the cross-linked polymer layer comprises thiol-ene.

36. The double barrier composite of claim 26 wherein the cross-linked polymer layer comprises a polymer formed from a blend of urethane acrylate oligomer and acrylate monomer.

37. The double barrier composite of claim 26 wherein the double barrier stack does not show barrier failure at a tensile strain of 1%.

38. The double barrier composite of claim 26 wherein the double barrier stack does not show barrier failure after 100,000 cycles at a tensile strain of 1%.

39. The double barrier composite of claim 26 further comprising a release liner on at least one of the first polymeric transfer layer or the second polymeric transfer layer.

40. The double barrier composite of claim 26 further comprising an adhesive layer disposed on one of the polymeric transfer layers.

41. The double barrier composite of claim 40 wherein the adhesive layer comprises a barrier adhesive.

42. The double barrier composite of claim 40 further comprising a release liner disposed on the adhesive layer opposite the polymeric transfer layer.

43. An encapsulated thin film device comprising the double barrier composite of claim 26 encapsulating a thin film device.

44. The encapsulated thin film device of claim 43 wherein the encapsulated thin film device has a thickness of less than about 200 microns.

45. The encapsulated thin film device of claim 43 wherein the device is an OLED.

46. The encapsulated thin film device of claim 43 wherein the device is selected from the group consisting of a solar cell, an electrophoretic display, an electrochromic display, a thin film battery, a quantum dot device, a sensor and combinations thereof.

47. The encapsulated thin film device of claim 43 further comprising a polarizer, a diffuser, a touch sensor or a combination thereof.

48. A method of encapsulating a thin film device comprising:
(a) providing a barrier composite comprising a gas-barrier film, a polymeric transfer layer disposed on the gas-barrier film and a release liner disposed on the polymeric transfer layer opposite the gas-barrier film;
(b) providing a thin film device; and
(c) adhering the barrier composite to the thin film device.

49. The method of claim 48 further comprising removing the release liner.

50. A method of encapsulating a thin film device comprising:
(a) providing a double barrier composite comprising
(i) a first barrier composite comprising a first gas-barrier film disposed on a first polymeric transfer layer, and a first release liner disposed on the opposite side of the first polymeric transfer layer;
(ii) a second barrier composite comprising a second gas-barrier film disposed on a second polymeric transfer layer, and a second release liner disposed on the opposite side of the second polymeric transfer layer;
(iii) a layer comprising a cross-linked polymer layer disposed between the first gas-barrier film and the second gas-barrier film,
(b) providing a thin film device;
(c) removing the first release liner; and
(d) adhering the double barrier composite to the thin film device.

51. A barrier composite comprising a gas-barrier film and a polymeric transfer layer disposed on the polymeric transfer layer wherein the barrier composite does not show barrier failure at a tensile strain of 1%.

52. A barrier composite comprising a gas-barrier film and a polymeric transfer layer disposed on the polymeric transfer layer wherein the barrier composite does not show barrier failure after 100,000 cycles at a tensile strain of 1%.
